(19) United States
(12) Patent Application Publication
(10) Pub. No.: US 2025/0239066 A1
(43) Pub. Date: Jul. 24, 2025

(54) Hierarchical Machine-Learned Agents For Performing Mixed Sequence Processing Tasks

(71) Applicant: Google LLC, Mountain View, CA (US)

(72) Inventors: Lluis Enric Castrejon Subira, Zurich (CH); Thomas Edgar Josef Mensink, Amsterdam (NL); Zhen Hao Zhou, Sunnyvale, CA (US); Vittorio Ferrari, Zurich (CH); Andre Filgueiras de Araujo, Belo Horizante (BR); Jasper Reinout Robertus Uijlings, Zurich (NL)

(21) Appl. No.: 19/020,630

(22) Filed: Jan. 14, 2025

Related U.S. Application Data
(60) Provisional application No. 63/624,632, filed on Jan. 24, 2024.

(51) Int. Cl. G06V 10/70; G06F 40/295

(52) U.S. Cl. CPC G06V 10/87; G06F 40/295

(57) ABSTRACT

A computing device can obtain a first machine-learned sequence processing model configured to use a plurality of first tools, wherein at least one first tool of the plurality of first tools is a second machine-learned sequence processing model configured to use one or more second tools. The computing device can obtain an input context. The computing device can select, using the first machine-learned sequence processing model based at least in part on the input context, a first tool of the plurality of first tools, wherein the first tool selected is the second machine-learned sequence processing model. The computing device can select, using the second machine-learned sequence processing model, at least one second tool of the one or more second tools. The computing device can generate, using the at least one second tool of the one or more second tools, a first output.

### CROSS-REFERENCE TO RELATED APPLICATIONS

The present application is based upon and claims the right of priority U.S. Provisional Patent Application No. 63/624,632, filed on Jan. 24, 2024, the disclosure of which, including any Appendices, is hereby incorporated by reference herein in its entirety for all purposes.

### FIELD

The present disclosure relates generally to machine learning processes and machine-learned devices and systems. More particularly, the present disclosure relates to systems and methods for using hierarchical machine-learned agents configured to use tools to perform tasks.

### BACKGROUND

In the fields of artificial intelligence (AI) and machine learning (ML), the ability to efficiently and accurately process and respond to a diverse set of tasks is a significant challenge. Traditional machine-learned models often specialize in a single type of task, such as image recognition, natural language processing, or data analysis. However, real-world applications frequently require the handling of mixed tasks that involve various types of data and necessitate different processing techniques. This can lead to inefficiencies and limitations in the adaptability and scalability of AI systems, as they may struggle to generalize across task types or require extensive retraining for each new task.

Moreover, with the increasing complexity of tasks, there is a growing need for AI systems to exhibit improved capabilities. Existing systems often lack the ability to transparently create a multi-stage approach for solving a task, making it difficult to understand the decision-making process, debug errors, and improve the system's performance iteratively.

Additionally, computational costs associated with training and running large-scale machine-learned models are substantial, encompassing not only the computational burden but also environmental concerns due to high energy consumption. There is a pressing need to optimize these models to achieve similar or improved performance with reduced computational overhead.

Furthermore, the rigidity of traditional AI systems hampers modular improvements and maintenance. Improvements made to a model for one specific task can inadvertently degrade its performance on other tasks, leading to a trade-off between specialization and generalization.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by one or more computing devices, a first machine-learned sequence processing model configured to use a plurality of first tools. In the example method, at least one first tool of the plurality of first tools can be a second machine-learned sequence processing model configured to use one or more second tools. The example method can include obtaining, by the one or more computing devices, an input context. The example method can include selecting, by the one or more computing devices using the first machine-learned sequence processing model based at least in part on the input context, a first tool of the plurality of first tools. In the example method, the first tool selected can be the second machine-learned sequence processing model. The example method can include selecting, by the one or more computing devices using the second machine-learned sequence processing model, at least one second tool of the one or more second tools. The example method can include generating, by the one or more computing devices using the at least one second tool of the one or more second tools, a first output.

In the example method, the plurality of first tools can include a plurality of respective machine-learned agents. In the example method, each respective machine-learned agent of the plurality of respective machine-learned agents can include a machine-learned sequence processing model configured to use one or more respective tools usable by the respective machine-learned agent.

In the example method, at least one respective machine-learned agent of the plurality of respective machine-learned agents of the plurality of respective machine-learned agents can be configured for visual question answering based on text retrieved using a text retrieval tool usable by the at least one respective machine-learned agent.

In the example method, the at least one respective machine-learned agent can be configured to determine, using one or more third tools configured to name one or more entities depicted in one or more images, a name of a first entity depicted in an input image. In the example method, the at least one respective machine-learned agent can be configured to retrieve, using the text retrieval tool based on the name of the first entity, the text. In the example method, the at least one respective machine-learned agent can be configured to output, based at least in part on the text, an answer to an input question.

In the example method, at least one respective machine-learned agent of the plurality of respective machine-learned agents can be configured for counting a number of objects in an image.

In the example method, at least one respective machine-learned agent of the plurality of respective machine-learned agents can be configured for answering a question about a particular portion of an image indicated by the input context.

In the example method, at least one respective machine-learned agent of the plurality of respective machine-learned agents can be configured for multi-image question answering.

In the example method, at least one respective machine-learned agent of the plurality of respective machine-learned agents can be configured for spatial reasoning.

In the example method, at least one respective machine-learned agent of the plurality of respective machine-learned agents can be configured for reasoning based on optical character recognition.

In the example method, the at least one respective machine-learned agent can be configured to identify, using one or more third tools based on an input image, one or more regions of the input image that comprise one or more natural language characters. In the example method, the at least one respective machine-learned agent can be configured to read, using one or more fourth tools configured to perform optical character recognition, the one or more natural language characters.

In the example method, at least one respective machine-learned agent of the plurality of respective machine-learned agents can be configured for performing multi-hop tasks using one or more decomposition tools configured to decompose an input to the at least one respective machine-learned agent.

In the example method, the at least one second tool can include a third machine-learned sequence processing model.

In the example method, the third machine-learned sequence processing model can be configured to use one or more third tools. In the example method, generating the first output can include selecting, by the one or more computing devices using the third machine-learned sequence processing model, at least one third tool of the one or more third tools. In the example method, generating the first output can include generating, by the one or more computing devices using the at least one third tool of the one or more third tools, a second output.

In the example method, at least one of the plurality of first tools and one or more second tools can include a caption generator.

In the example method, at least one of the plurality of first tools and one or more second tools comprises an image cropping tool.

The example method can include generating, by the one or more computing devices using the second machine-learned sequence processing model, one or more instructions for the at least one second tool. In the example method, the one or more instructions can include at least one variable name. In the example method, the first output can be generated based at least in part on data associated with the at least one variable name.

The example method can include storing, on one or more non-transitory computer-readable media in one or more locations associated with a variable name, the first output. The example method can include generating, by the one or more computing devices using the second machine-learned sequence processing model, one or more instructions configured to use an additional tool of the one or more second tools. The example method can include generating, by the one or more computing devices using the additional tool, a second output. In the example method, the one or more instructions can include the variable name. In the example method, the second output can be generated based at least in part on data associated with the variable name.

The example method can include storing, on one or more non-transitory computer-readable media in a location associated with a variable name, the input context. The example method can include generating, by the one or more computing devices using the first machine-learned sequence processing model, one or more instructions for the second machine-learned sequence processing model. In the example method, the one or more instructions can include the variable name. In the example method, the at least one second tool of the one or more second tools can be selected based at least in part on data associated with the variable name.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining a first machine-learned sequence processing model configured to use a plurality of first tools. In the example operations, at least one first tool of the plurality of first tools can be a second machine-learned sequence processing model configured to use one or more second tools. The example operations can include obtaining an input context. The example operations can include selecting, using the first machine-learned sequence processing model based at least in part on the input context, a first tool of the plurality of first tools. In the example operations, the first tool selected can be the second machine-learned sequence processing model. The example operations can include selecting, using the second machine-learned sequence processing model, at least one second tool of the one or more second tools. The example operations can include generating, using the at least one second tool of the one or more second tools, a first output.

Example aspects of the present disclosure provide one or more example non-transitory computer-readable media storing instructions that are executable by one or more processors to cause a computing system to perform example operations. In some implementations, the example operations can include obtaining a first machine-learned sequence processing model configured to use a plurality of first tools. In the example operations, at least one first tool of the plurality of first tools can be a second machine-learned sequence processing model configured to use one or more second tools. The example operations can include obtaining an input context. The example operations can include selecting, using the first machine-learned sequence processing model based at least in part on the input context, a first tool of the plurality of first tools. In the example operations, the first tool selected can be the second machine-learned sequence processing model. The example operations can include selecting, using the second machine-learned sequence processing model, at least one second tool of the one or more second tools. The example operations can include generating, using the at least one second tool of the one or more second tools, a first output.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system for performing tasks using hierarchical machine-learned agents according to example implementations of aspects of the present disclosure.

FIG. 2 is a block diagram of an example system for performing tasks including visual question answering tasks using hierarchical machine-learned agents according to example implementations of aspects of the present disclosure.

FIG. 3 is a block diagram of an example system for performing tasks using hierarchical machine-learned agents according to example implementations of aspects of the present disclosure.

FIG. 4 depicts a flowchart diagram of an example method for machine-learned inference using hierarchical machine-learned agents according to example implementations of aspects of the present disclosure.

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

### Overview

Generally, the present disclosure provides a hierarchical system of machine learning models that can interact with each other and various tools to perform tasks. The proposed systems allow the models, or “agents,” to call upon other specialized agents in a hierarchical fashion. This means that the task of solving a complex problem can be divided among different agents, each focusing on different parts of the problem according to their specialization, making the process more efficient and manageable. This hierarchical approach enhances the system's ability to handle a wide variety of tasks, including visual question answering, spatial reasoning, and many others. The approach also facilitates improvements in the overall system, as enhancing one specialized agent would lead to better performance in its area of focus. In this manner, systems and methods of the present disclosure can outperform other methods in a general setting, with significant improvements in accuracy.

More particularly, the present disclosure is directed to systems and methods for using hierarchical machine-learned agents to perform mixed tasks characterized by a plurality of possible task types. An agent can be, for example, a machine-learned model (e.g., sequence processing model) configured to use other tools (e.g., other machine-learned models, software tools, interfaces such as APIs, etc.). In some instances, a “dispatcher” agent can be configured to use a plurality of tools, which can include a plurality of “worker” agents. In some instances, the worker agents can include one or more specialized agents configured to perform a specialized task type. Thus, in some instances, an agent's set of “tools” can include another agent. For example, a first agent may call upon a second agent to perform a certain subtask or set of subtasks and, thus, the second agent may be viewed as a tool of the first agent.

As such, the interoperation of these multiple agents can in some instances form a multi-layer hierarchy of agents, each configured to use its own set of tools, which may overlap or not overlap with another agent's toolset. In some instances, the agents can comprise sequence processing models (e.g., language models) and a mechanism for using the agent's tools can include outputting one or more instruction sequences (e.g. computer code, pseudocode, natural language instructions, etc.) for using a tool. Based on a first output from one or more tools, an agent can generate a second output, which can be provided, for example, to a user or to another agent such as a top-level dispatcher agent or other agent located in a higher layer of the hierarchy.

In some instances, an agent can be configured to use tools and perform tasks with chain of thought prompting (e.g., chain-of-thought prompting of a pretrained language model). For example, an agent can be prompted with a plurality of example task inputs, along with a plurality of example thought processes for performing the respective tasks. In some instances, each example thought process can include a plurality of delimiters configured to mark each part of the example thought process (e.g., “[Thought],” “[Act],” “[Observe]”; “input:”, “tool choice:”, “tool instruction:”; “1” “2” “3”; etc.). An example thought process can include, for example, one or more planning components; one or more action selection components; one or more action result components; and one or more output components. An action selection component can include, for example, an instruction to use a tool. An action result can include, for example, an agent-readable output of a used tool or an agent-readable summary of a tool's action (e.g., a variable name associated with the tool's output).

In some instances, each agent's prompt(s) (e.g., which can be predefined and input consistently at each inference call of the agent) can be designed to configure the agent for a particular task. For example, a dispatcher agent may be prompted with a plurality of example tasks from a wide variety of task types, along with a plurality of example thought processes for selecting and using the best agent for a particular task type. In another example, a specialized worker agent may be prompted with a plurality of example tasks of one specialized type (e.g., visual counting tasks, etc.), along with a plurality of example thought processes for performing the specialized task.

In some example implementations, a specialized agent can be configured by providing specialized chain-of-thought prompts configured for a specialized task. In some instances, the specialized chain-of-thought prompts can be refined by testing a plurality of candidate agents, prompted with a plurality of candidate chain-of-thought prompts, on a training dataset of specialized tasks. In some instances, an agent can be further refined (or specialized) via, for example, fine-tuning on a training dataset configured based on the agent's assigned task (e.g., dispatcher dataset comprising human labels indicating an optimal choice of specialized agent, etc.). However, fine-tuning is not required.

In some instances, an example thought process associated with chain-of-thought prompting can include example instructions for using one or more tools (e.g., “[Act]: article=WikipediaArticle (‘Alexandria’)”, etc.). In this manner, an agent can be configured to output similar instructions for using the one or more tools in response to an input task (e.g., “[Act]: article=WikipediaArticle (‘Berlin’)”, etc.). In some instances, an output of the agent can be processed to identify and carry out instructions generated by the agent. For example, an output of the agent can be parsed (e.g., based on delimiter tag such as “[Act]:” and “[Finish]:”), and one or more agent-generated instructions can be extracted from the parsed output. In some instances, the parsed output can be checked for correctness (e.g., correct syntax, valid tool name, valid tool inputs, etc.). If a valid agent-generated instruction is detected, a computing system may use a tool based on the instruction.

In some instances, a hierarchical agent-based system can be configured to be multimodal. For example, in some instances, an agent-generated instruction can include an instruction to use one or more data variables (e.g., by including a variable name in an agent-generated instruction). In some instances, the data variable can be configured to store a data type that is different from a data type of the agent or a chain-of-thought reasoning chain associated with the agent. For example, in some instances, an agent configured to work with text-based data (e.g., a text-only agent, a multimodal agent configured to output a text-based reasoning chain, etc.) can generate instructions to store non-text data in one or more variables, which can be used by one or more tools, other agents, etc. In this manner, for instance, a hierarchical system of agents can be configured to process arbitrary data of any data type (and any combination of data types) without necessarily requiring a machine-learned agent to natively process each data type. In this manner, for instance, a multimodal agent-based system can be built from a plurality of unimodal agents. Additionally, in some instances, one or more agents or tools can be multimodal themselves (e.g., vision language models, audio language models, etc.). In some instances, a multimodal agent can generate chain-of-thought reasoning outputs in a first mode (e.g., text, etc.), wherein the reasoning outputs may refer to data variables in a second mode (e.g., image, audio, video, etc.) different from the first mode. In this manner, for instance, a multimodal model can be configured to perform multimodal chain-of-thought reasoning with reduced usage of computationally expensive multimodal inputs (e.g., multimodal chain-of-thought prompts, etc.) compared to some alternative implementations.

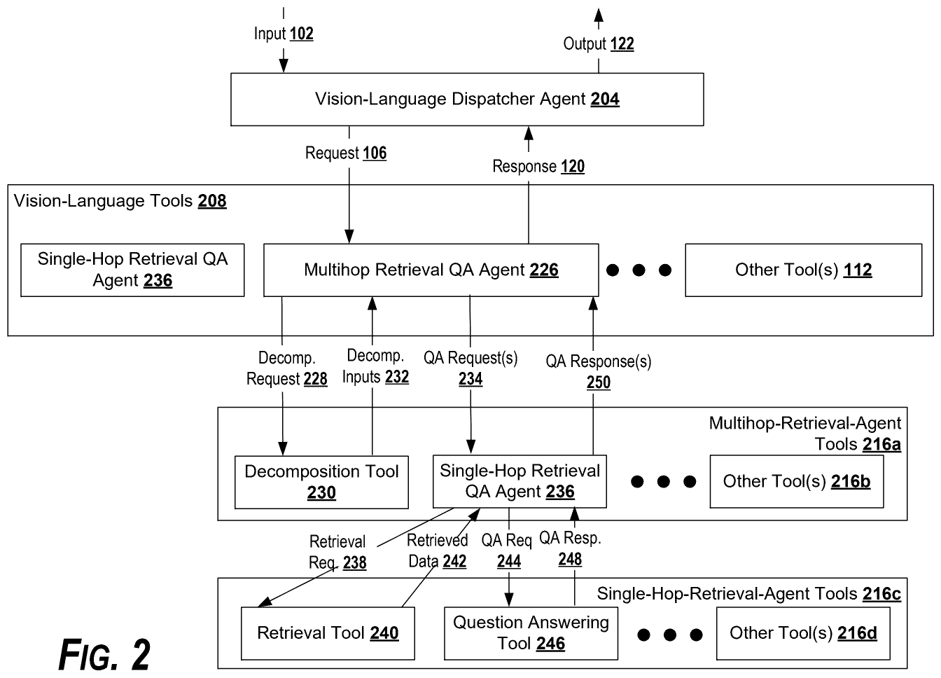

One example application of a hierarchical agent-based system of the present disclosure can include visual question answering. For example, a plurality of specialized visual question answering agents can be configured to perform a plurality of specialized tasks (e.g., encyclopedic question answering, visual counting tasks, spatial reasoning, optical character recognition, multi-image question answering, etc.). Additionally or alternatively, one or more generalist or multi-task visual question answering tools can be obtained (e.g., vision language model trained on a plurality of task types, etc.). A dispatcher agent can be configured to select an agent or tool to answer an input question (e.g., based solely on the question, or after using one or more tools such as an image captioning tool, etc.). Each specialized agent can be configured to use one or more tools (e.g. other agents, knowledge retriever, image captioner, image cropper, visual question answering machine-learned model, text-based question-answering machine-learned model, optical character recognition tool, image-based object detector, image-based entity identifier, question decomposer, etc.). Additional example implementation details (e.g. agent types, tool types, prompting information, etc.) for visual question answering are provided below with respect to FIG. 2. In example visual question answering experiments according to the present disclosure, hierarchical agent systems of the present disclosure outperformed some alternative visual question answering systems on a variety of task types. Additional information on example visual question answering results is provided below and in the Appendix to U.S. Provisional Patent Application No. 63/624,632, which is incorporated by reference herein and forms a part of this disclosure.

Systems and methods of the present disclosure provide a variety of technical effects and benefits. For example, systems and methods of the present disclosure can in some instances provide improved technical performance (e.g., improved inference accuracy over a plurality of specialized tasks) compared to prior systems and methods. In some instances, systems and methods of the present disclosure can achieve similar (e.g., same) technical performance at a reduced cost (e.g., computational cost such as electricity cost, memory usage, etc.) compared to prior systems and methods.

As one example, in some example experiments, systems and methods of the present disclosure outperformed both prior agent-based methods and prior non-agent-based vision language models on a variety of visual question answering tasks. For some example tasks, systems and methods of the present disclosure achieved accuracies up to 13 times higher (65.1 percent vs. 5 percent accuracy), with an average performance nearly 50 percent higher (39.7 percent vs. 26.7 percent accuracy) compared to some alternative agent-based systems and methods for general-purpose visual question answering. In other example experiments, systems and methods of the present disclosure performed on average 7 percent better than a prior general-purpose vision language model, even when the example tasks included data on which the vision language model was trained. Additional details and example results are provided below and in the Appendix to U.S. Provisional Patent Application No. 63/624,632, which is incorporated by reference herein and forms a part of this disclosure.

In some instances, systems and methods of the present disclosure can provide reduced computational cost (e.g., electricity cost, memory usage, processor usage, etc.) compared to alternative systems and methods. For example, systems and methods of the present disclosure can reduce a prompt length for configuring an agent compared to alternative generalist agent-based systems and methods. In some instances, a computational cost associated with a sequence processing model (e.g., a self-attention cost) can be proportional to a square of a context length. Therefore, reducing a prompt length of one or more agents can reduce a computational cost of performing an agent-based task compared to prior systems and methods. Reducing a prompt length of an agent can also have additional technical effects and benefits, such as preventing a context window of the agent from being “clogged” with irrelevant context, thereby allowing the agent to devote more attention to the most relevant context information.

Additionally, in some instances, systems and methods of the present disclosure can facilitate reduced-computational-cost unimodal (e.g., text-only, etc.) chain-of-thought prompting (e.g., text-only example input-reasoning-output tuples that refer to text-based variable names, etc.) to perform a multimodal task by generating a multimodal reasoning chain, thereby reducing a computational cost of machine-learned inference compared to some alternative implementations.

Additionally, inference accuracy of a machine-learned model can in some instances be correlated with a computational cost of the machine-learned model (e.g., in instances where additional parameters can lead to increased cost and improved accuracy). For this reason, the improved inference accuracy of provided systems and methods can also facilitate a reduction in computational cost by permitting similar (e.g., same) technical performance using a lower-cost (e.g., smaller) machine-learned model.

Systems and methods of the present disclosure can also provide improved generality and flexibility compared to alternative methods. For example, in some example experiments, systems and methods of the present disclosure were compared to alternative single-agent specialized agents for performing example specialized visual question answering tasks. In the experiments, a generalist system of the present disclosure provided performance similar to the performance of single-agent specialist systems on most of the specialized tasks tested. In the experiments, the generalist system of the present disclosure was configured to perform eight times as many task types compared to the single-agent specialist systems. Thus, systems and methods of the present disclosure can provide improved generality and flexibility compared to prior systems and methods, with similar inference accuracy.

In some instances, systems and methods of the present disclosure can reduce a debugging or maintenance cost compared to prior methods. For example, in instances where one or more system components (e.g., agents, tools, etc.) may make an error (e.g., inaccurate machine-learned inference, software bug, etc.), systems and methods of the present disclosure can allow a failure mode to be more clearly identified compared to prior systems and methods. In such instances, knowledge of a failure mode can facilitate debugging at reduced cost (e.g., computational cost, labor cost, etc.) compared to prior systems and methods. For example, if a bug is associated with inaccurate machine-learned inference by a tool or agent, debugging may include further training (e.g., fine-tuning) of the tool or agent. When a failure mode is clearly identified, the relevant component can in some instances be retrained at a lower computational cost (e.g., using fewer training iterations) compared to prior systems and methods. For example, a clearly identified failure mode can prevent unnecessary training of components that are not causing errors or can facilitate training on a specialized dataset related to the failure mode, thereby permitting retraining using fewer training instances compared to prior methods.

In some instances, systems and methods of the present disclosure can facilitate modular improvement, which can in some instances reduce a cost associated with improving an overall system. For example, in some implementations according to the present disclosure, a plurality of specialized agents can be used for a plurality of specialized tasks. In such instances, each specialized agent can be separately improved in relation to its own specialized task, without any effect on the performance of other specialized agents. In this manner, for instance, a system can be modularly improved, one agent at a time or one task type at a time. This is in contrast to prior systems and methods such as single-agent methods, where an improvement in an agent's ability to perform one task may harm that agent's ability to perform another task, making overall system improvement difficult and expensive in some instances.

Although provided example results relate to visual question answering, systems and methods of the present disclosure are not limited to visual applications or to question answering. Other example applications can include, for example, sequence generation such as audio generation (e.g., speech, music); text generation (e.g., creative writing, task-focused text generation such as legal writing); sequence classification or modeling (e.g., signal processing, biological or chemical sequencing, economic sequence modeling, etc.); computer programming tasks (e.g., code generation); image tasks (e.g., generation, classification, etc.); multimodal tasks; or performance of any complex computer-implemented task based on a sequential input context (e.g., human-readable task instructions, etc.). As a non-limiting illustrative example, a code generation hierarchical agent system can include, for example, a plurality of specialized agents configured to generate code in a plurality of coding languages (e.g., Python, Java, C, etc.), or configured to perform a plurality of coding task types. Each agent can have use to a plurality of language-specific tools (e.g., compilers; syntax checkers; unit testing tools; etc.) or task-specific tools. In principle, tools can include any computer-executable instructions or computer-controllable systems, and systems and methods of the present disclosure can therefore be adapted to any computer-implemented task where the reasoning powers of a machine-learned agent may be helpful for coordinating the task.

Although terms such as “dispatcher” agent and “worker” agent are used for illustrative purposes, the present disclosure does not require a strict separation between only two types of agents. For example, in some instances a top-level dispatcher agent may be configured to perform some tasks without the use of an agent; a hierarchical system may include one or more sub-dispatcher agents; a worker agent may use another worker agent as a tool; etc. And although the present disclosure discusses specialized worker agents for illustrative purposes, the worker agents can include one or more generalist agents configured to perform more than one task type without going outside of the scope of the present disclosure.

Similarly, although the term “hierarchical” is used to describe a system wherein agents can call other agents, a strictly defined hierarchy of agents is not required. For example, in some instances, a dispatcher agent can be configured to use a first worker agent and a second worker agent, and the first worker agent can be configured to use the second worker agent as a tool. In some instances, a first agent may be configured to call a second agent using a first input, and the second agent may in some instances be configured to call the first agent using a second input. In some instances, an agent may use itself as a tool. In this manner, for instance, a system can have a configuration that is not strictly hierarchical (e.g., loosely hierarchical, recursive, etc.) without going outside the scope of the present disclosure.

Various example implementations are described herein with respect to the accompanying Figures.

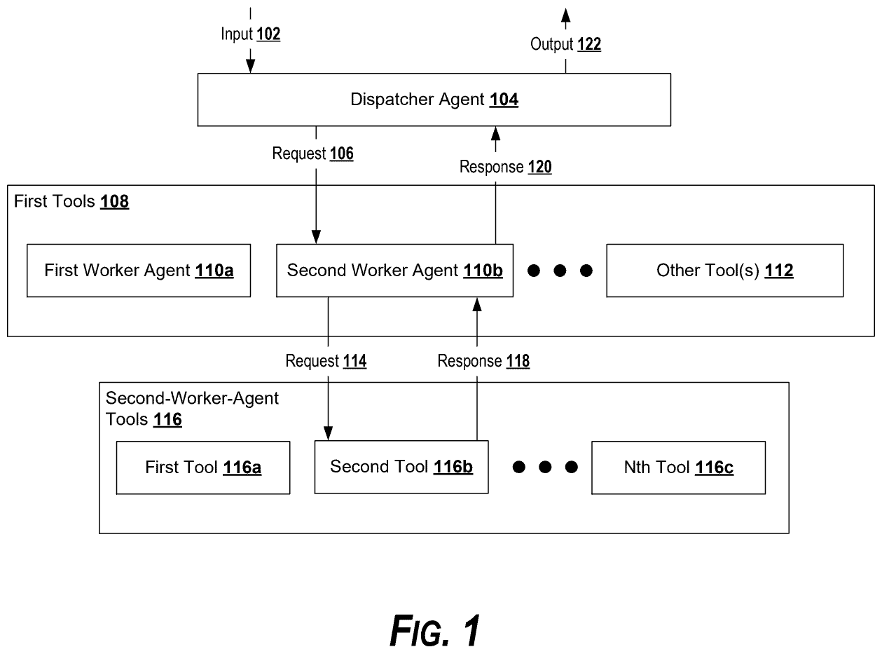

FIG. 1 is a block diagram of an example system for performing tasks using hierarchical machine-learned agents according to example implementations of aspects of the present disclosure. A dispatcher agent 104 can receive one or more inputs 102, such as input(s) 102 indicative of a task to be performed. Based on the input(s) 102, the dispatcher agent 104 can select one or more first tools 108, such as one or more worker agents 110 or other tools 112, to perform one or more actions. For example, the dispatcher agent 104 can select a second worker agent 110b of a plurality of worker agents 110, and can provide one or more requests 106 to the second worker agent 110, such as a request to perform a task associated with the input(s) 102. Based on the request(s) 106, the second worker agent 110b can select one or more tools (e.g., second tool 116b as depicted in FIG. 1) of a plurality of tools 116 accessible to (e.g., usable by, etc.) the second worker agent 110b, and can send one or more requests 114 to the selected tool(s) 116. Based on the request(s) 114, the selected tool(s) 116 can perform one or more actions, and can provide one or more responses 118 to the second worker agent 110b generated by the actions. Based on the response(s) 118, the second worker agent 110b can provide one or more responses 120 to the dispatcher agent 104. Based on the response(s) 120, the dispatcher agent 104 can output one or more output(s) 122 (e.g., to a user, to another computing device, to an application programming interface, etc.).

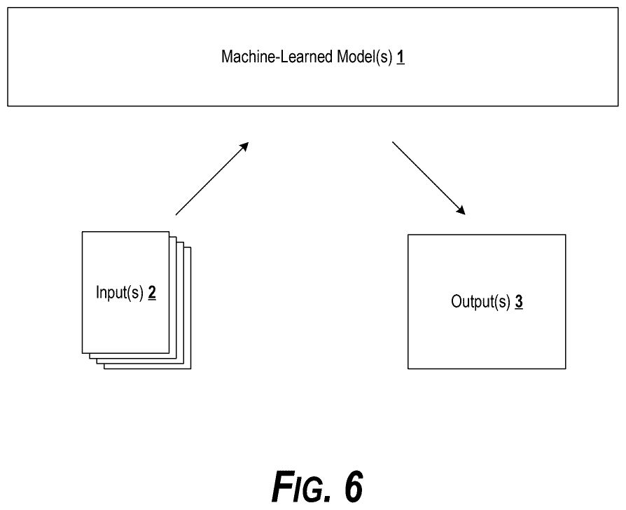

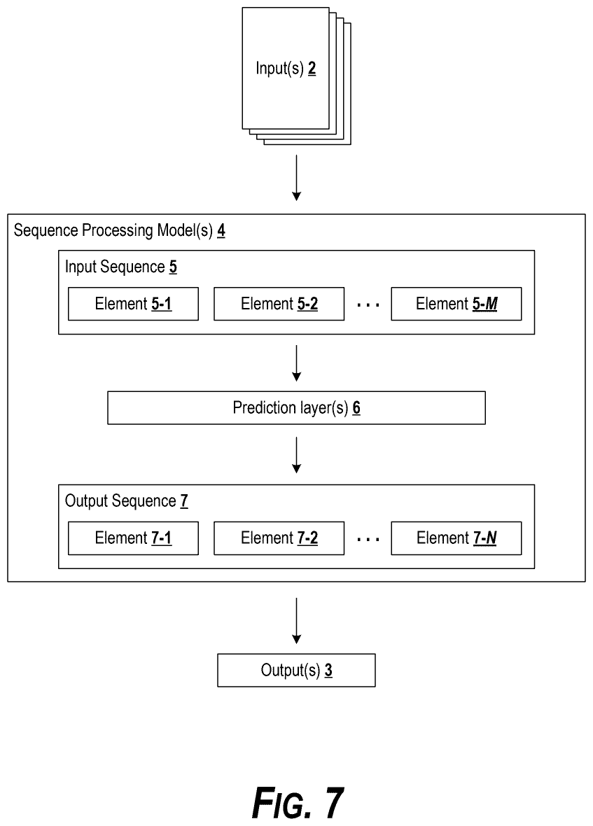

An input 102 can generally include or otherwise represent various types of data. An input 102 can include one type or many different types of data. For example, in some instances, an input 102 can include a multimodal input context directed to a multimodal machine-learned model, such as an input context comprising natural language data (e.g., text, speech, etc.) and visual data (e.g., image data, video data, etc.), or other multimodal input. As another example, in some instances, an input 102 can include a unimodal (e.g., text-only, etc.) input 102 comprising one or more references (e.g., variable names, etc.) to data of a second mode (e.g., image, audio, video, etc.). Example data types for an input 102 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type.

In some instances, an input 102 can include data indicative of a task to be performed by the dispatcher agent 104 using one or more tools 108 (e.g., using one or more worker agents 110, etc.), such as data indicative of a user query, user request, user instruction, or other data indicative of a task to be performed. In some instances, an input 102 can further include or not include in-context learning data, such as data describing the tools 108 or describing a means for calling the tools 108; chain-of-thought prompting data; few-shot prompt data; system prompt data; instruction data; or other in-context learning data. However, this is not required. For example, in some instances, a dispatcher agent 104 can include an agent 104 that has been pretrained or fine-tuned model using tool 108 selection data (e.g., training examples comprising input-output pairs comprising a user query input and a corresponding tool 108 selection output, input-reasoning-output tuples comprising a user query input and a reasoning chain comprising a tool 108 selection, etc.), such that the dispatcher agent 104 can select one or more tools 108 based on a user query, without necessarily requiring additional in-context learning data.

In some instances, in-context learning data can include chain-of-thought content configured to cause the dispatcher agent 104 to select a tool 108 or action based on the input 102. In some instances, chain-of-thought content can include one or more example input-reasoning-output tuples (e.g., triplets, etc.), such as an example input comprising a task to be performed; a corresponding chain of reasoning comprising one or more steps for performing the task; and an example output associated with the example task. In some instances, an example chain of reasoning of an input-reasoning-output tuple can include one or more thought, observation, or action steps. As a non-limiting illustrative example, in some instances, a tool 108 can include a worker agent 110 configured to answer multi-hop questions, such as multi-part questions that may require answering a first component of the question before a second component of the question can be understood or answered (e.g., “What is the largest company by market capitalization on the NASDAQ, and when was its IPO?”, etc.); implicit-knowledge questions that may require retrieving or identifying data that is not expressly included in the question before the question can be understood or answered (e.g., “When was the wife of the first president of the United States born?”, etc.), or the like. In such instances, an example input-reasoning-output tuple to cause the dispatcher agent 104 to select the multi-hop question worker agent 110 when appropriate can include an example input comprising a multihop question; an example thought recognizing that the input comprises as multihop question (e.g., “[Thought]: This is a multi-part question that would be easier to answer if I broke it down into its component parts.”, etc.); an example action comprising a tool selection output (e.g., “[Act]: multiHopQA(query)”, etc.); an example observation comprising an example response associated with a selected tool (e.g., “[Observe]: Jun. 2, 1731”, etc.); and an example output comprising an output based on or associated with the response (e.g., “[Finish]: Jun. 2, 1731”, etc.). In some instances, an example input-reasoning-output tuple can include a plurality of delimiters configured to mark each part of the example thought process (e.g., “[Thought],” “[Act],” “[Observe]”; “input:”, “tool choice:”, “tool instruction:”; “1” “2” “3”; etc.). An example chain of reasoning can include, for example, one or more planning components; one or more action selection components; one or more action result components; and one or more output components.

In some instances, an example chain-of-thought prompt can include an action selection component comprising an instruction for using one or more tools (e.g., “[Act]: contextRetrieval(“Eiffel Tower”)”; etc.). In some instances, an example instruction can be in a structured or standardized format, such as a structured or standardized format associated with an action space. In some instances, a structured or standardized format can include a format (e.g., syntax, etc.) associated with a computer coding language (e.g., Python, C, etc.); a format associated with an application programming interface (API), a structure associated with a markup language or object notation language (e.g., extensible Markup Language (XML), JavaScript Object Notation (JSON), etc.), a structure associated with a pseudocode or interpretable instruction set (e.g., pseudocode or request 106, 114 format to be interpreted by glue code associated with an agent 104, 110, etc.), or other structure (e.g., comma-separated value, etc.).

In some instances, in-context learning data can include tool 108 data (e.g., natural language data, such as natural language description or instruction data, etc.; other language data, such as programming language data; structured data such as JSON-structured data indicative of one or more tools 108; etc.) indicative of one or more tools 108, such as natural language data describing the tool(s) 108 (e.g., “The multihopQA tool can be used to answer multipart questions, questions requiring implicit knowledge to answer, or other questions that may require multiple steps to answer.”, etc.), mechanisms for calling the tool(s) 108 (e.g., “The multihopQA can be called by outputting a tool call in the following format: multihopQA(query),” etc.), or the like. In some instances, in-context learning data can include system prompt data or other instruction data instructing the dispatcher agent 104 to select an appropriate worker agent 104 (e.g., “Your task is to select the best worker agent for performing the user-defined task below. You may select from the following set of worker agents:”, etc.). In some instances, in-context learning data can include least-to-most prompting, self-critique, or other prompting content. Other in-context learning data is possible.

In some instances, input(s) 102 can include input(s) 102 stored in a data structure that is referenced by a variable, pointer, reference, or the like. For example, in some instances, input(s) 102 can include multimodal inputs 102. In some instances, multimodal inputs 102 can include a first input having a first mode (e.g., image, audio, video, etc.) stored in a first data structure (e.g., variable; object; file or folder; struct; data entry of a database, such as database row, cell, table, column, or the like; or other data structure), and a second input having a second mode (e.g., text, natural language, programming language, source code, object code, machine code, bytecode, etc.), wherein the second mode comprises a reference (e.g., variable name, pointer, data entry identifier such as database primary key, filename, etc.) to the first input. In some instances, multimodal inputs 102 can include a plurality of first inputs having one first mode or a plurality of first modes, and a second input can include a plurality of respective references (e.g., variable names in a text, natural language, or programming language format, etc.) to each of a plurality of respective data structures.

As a non-limiting illustrative example, in some instances, an input 102 can include an image input that is stored in an image data structure (e.g., image file, etc.) referenced by a variable name such as “image”. Continuing the example, in some instances, in-context reasoning content of the input(s) 102 can include example input-reasoning-output tuples comprising example tool 108 calls as part of the reasoning process, wherein the example tool 108 calls can use the variable name “image,” thereby causing, in some instances, the dispatcher agent 104 to use the variable name “image” in its requests 106 or other outputs. As a non-limiting illustrative example, an example chain-of-thought reasoning chain of an example input 102 can use the variable names ‘image’ and ‘crop’ in the following manner: “[Thought]: I need to crop the top left corner of the image. [Act]: crop=CropImage(image, [0, 0, 50, 50]) [Observe]: Output of ‘CropImage’ is stored in the variable: ‘crop’”. Any number or type of variable names or other references can be used, and data structures referred to by references can include data of any data type (including, e.g., data types that are the same as or different from a data type in which a chain-of-thought reasoning chain is expressed, such as text). In this manner, for instance, a dispatcher agent 104 can be configured to perform a machine-learned reasoning process (e.g., multistep reasoning process, reasoning chain, etc.) in a multimodal context by including, in a reasoning chain associated with a first mode (e.g., text, etc.), relevant references to data of other modes, thereby enabling a first-mode (e.g., text-based, etc.) reasoning chain to consider and account for multimodal data of other modes.

A dispatcher agent 104 can include one or more machine-learned models. The dispatcher agent 104 can include various model architectures, such as various neural network model architectures. An example model architecture for a dispatcher agent 104 can include a sequence processing model architecture (e.g., a transformer model). For example, the dispatcher agent 104 can be configured to receive an input sequence and generate an output sequence. For instance, the dispatcher agent 104 can be configured to generate an output sequence where elements of the output sequence are predicted based on the elements of the input sequence. In some instances, a dispatcher agent 104 can include a model architecture having an attention mechanism (e.g., self-attention). In some instances, the dispatcher agent 104 can include a pre-trained model (e.g., pretrained using large-scale unsupervised learning). In some instances, the dispatcher agent 104 can be fine-tuned over one or more fine-tuning datasets, such as a fine-tuning dataset associated with a tool 108 selection task (e.g., fine-tuning datasets comprising user query-task selection pairs, etc.). In some instances, a dispatcher agent 104 can include a multimodal machine-learned model configured to receive inputs 102 having a plurality of data types, such as an input context comprising natural language data (e.g., text, speech, etc.) and visual data (e.g., image data, video data, etc.), or other multimodal input. In other instances, a dispatcher agent 104 can include a unimodal (e.g., text-only, etc.) model configured to reason about data of other modes (e.g., image, audio, video, etc.) using references (e.g., variable names, etc.) to data structures comprising data of the other modes; outputs from multimodal tools that can operate on data of other modes; or the like. Further details of an example system comprising a vision-language dispatcher agent (e.g., multimodal vision-language dispatcher agent, etc.) are provided below with respect to FIG. 2.

In some instances, a dispatcher agent 104 can include a machine-learned agent 104 configured to select one or more specialized worker agents 110 or other tools 112 for performing a task associated with an input 102 (e.g., answering a user question contained in the input 102, satisfying a user request contained in the input 102, etc.) from a set of available worker agents 110 or tools 108 based on the input(s) 102, or to select an action to be performed by a selected tool 108 from an action space. In some instances, the dispatcher agent 104 can be configured to make the selection based on in-context learning data contained in the input 102 (e.g., as described above), or can be configured (e.g., pretrained or fine-tuned on input 102-tool selection pairs, etc.) to make the selection without necessarily requiring in-context learning content.

In some instances, the dispatcher agent 104 can include a machine-learned model that has been provided with data indicative of the set of tools 108 or the action space. For example, in some instances, the dispatcher agent 104 can be provided with toolset data as input 102 context (e.g., in addition to a user query, user instruction, request, or the like), and the dispatcher agent 104 can select one or more tools or actions based on the input context using in-context learning. As another example, in some instances, the dispatcher agent 104 can include a machine-learned model that has been trained (e.g., pretrained, fine-tuned, etc.) using data indicative of the toolset or action space. In some instances, data indicative of the toolset or action space (e.g., data provided via an input context, etc.) can include data associated with one or more tools 108, such as data describing a manner of invoking one or more tools 108, data listing a plurality of actions that can be performed by one or more tools 108, or other data. In some instances, data indicative of the action space (e.g., training data, data provided via an input context, etc.) can include one or more input-output pairs, such as pairs comprising an input context (e.g., user input describing a task to be performed) and a corresponding output value indicative of an action selection or tool selection (e.g., tool name or tool identifier; output sequence such as computer code, pseudocode, function call, application programming interface (API) call, or the like; or other action or tool selection output). In some instances, example input-output pairs can be provided as input context to the dispatcher agent 104 according to one or more prompting techniques (e.g., few-shot prompting, chain-of-thought prompting, etc.). In some instances, the dispatcher agent 104 can be trained using example input-output pairs, such as by providing an input of an input-output pair to the dispatcher agent 104; generating, by the dispatcher agent 104 based at least in part on the input, a training output; determining, by a computing system based at least in part on the training output and an objective function (e.g., loss function based on a comparison between the training output and a ground truth output, etc.), one or more parameter updates for the dispatcher agent 104; and updating the dispatcher agent 104 according to the parameter updates.

A request 106 can include, for example, an output generated by a dispatcher agent 104. A request 106 can include data indicative of one or more first tools 108 selected by the dispatcher agent 104 based on the input(s) 102; one or more selected action(s) to be performed by the selected first tool 108; one or more parameters, variables, inputs, or the like associated with the selected action(s); or other action selection content.

A request 106 can generally include or otherwise represent various types of data. A request 106 can include one type or many different types of data. A request 106 can include one or more data types that are similar to (e.g., same as) or different from one or more data types of an input 102. Example data types for an request 106 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type.

In some instances, a request 106 can include computer-executable instructions (e.g., code a programming language such as a call to an application programming interface (API), object code, compiled code, bytecode, etc.) or other data indicative of a selected action to be performed by a selected tool (e.g., function name, first tool 108 name, function parameters or tool parameters such as variable names, etc.). For example, in some instances, a request 106 can include a structured action selection output in a format recognized by a parser, interpreter, or similar module configured to parse or interpret outputs of the dispatcher agent 104 and identify selected first tools 108 or actions to be performed by the first tools 108.

In some instances, a request 106 can include or not include input context (e.g., multimodal input context, etc.) configured to be provided to a worker agent 110. For example, although FIG. 1 depicts a request 106 being provided directly from a dispatcher agent 104 to a worker agent 110, in some instances, a dispatcher agent 104 can output (e.g., to a parser, interpreter, glue code, or the like) a request 106 indicative of a selected tool 108 or selected action to be performed by the selected tool 108, and one or more computing components (e.g., software, firmware, or hardware component(s), etc.) other than the dispatcher agent 104 can cause, responsive to receiving the request 106, the selected tool 108 to perform the selected action. In some instances, causing a selected tool 108 (e.g., a worker agent 110, etc.) to perform a selected action can include providing the tool 108 with input(s) that may be the same as or different from content received in the request 106. As a non-limiting illustrative example, in some instances, a request 106 can include a tool call (e.g., tool call having a structured format or syntax, etc.) comprising a tool 108 identifier (e.g., name, etc.) and zero or more other values (e.g., input parameters, etc.), and a computing system (e.g., using an interpreter, parser, glue code, etc.) can identify the tool call in the request 106 and implement the tool call by providing input(s) to the selected tool 108.

In some instances, an output (e.g. request 106, 114, etc.) of an agent 104, 110 can be processed to identify and carry out selected actions identified in a request 106, 114. For example, in some instances, a computing system can parse an output of the agent 104, 110 (e.g., based on delimiter tags such as “[Act]:” and “[Finish]:”), and one or more action selections 110 can be extracted from the parsed output. In some instances, the parsed output can be checked for correctness (e.g., correct syntax, valid tool name, valid tool inputs, etc.). If a valid action selection is detected, a computing system may cause a tool 108, 116 to perform the selected action. As a non-limiting illustrative example, in some instances, a request 106, 114 can include a first delimiter indicative of an action selection or tool 108, 116 selection (e.g., “[Act]:”, etc.) followed by data (e.g., text data, language data, binary data, sequence data, etc.) indicative of a tool 108, 116 selection, action selection, action or tool parameters, inputs to a tool or function, or the like. In some instances, parsing a request 106, 114 can include parsing based on the first delimiter (e.g., using a regular expression comprising data indicative of the first delimiter, etc.) to extract an action selection or tool selection output segment; parsing the action/tool selection output segment to extract one or more of an action identifier (e.g., name, etc.) or tool identifier, action or tool parameter(s), and input(s) to a tool or function; and performing a selected action based on the extracted data (e.g., based on a mapping from a tool identifier to an API function; based on a mapping from tool parameters or inputs to corresponding parameters of the API function; etc.).

In some instances, causing a tool 108, 116 to perform an action can include mapping a request 106, 114 to corresponding executable code (e.g., corresponding application programming interface (API) call, etc.) and executing the executable code. In some instances, mapping a request 106, 114 to executable code can include retrieving corresponding executable code (e.g., corresponding API call, etc.) from a data structure (e.g., database, table, row, column, file, object, etc.) based at least in part in part on the request 106, 114 (e.g., based on a tool identifier, etc.). In some instances, mapping the request 106, 114 to executable code can include passing the request 106, 114 to glue code (e.g., glue code comprising one or more compiler, interpreter, or parser functions, etc.) configured to map requests 106, 114 to executable actions.

In some instances, a computing system (e.g., using an interpreter, parser, glue code, etc.) can validate a tool call identified in the request 106 and can select an appropriate action based on the validation. For example, the computing system can, responsive to determining that a tool selection component of the request 106 is valid, call a selected tool 108 according to the tool selection output. As another example, the computing system can, responsive to determining that a tool selection output of the request 106 is invalid, provide the dispatcher agent 104 with additional input(s) 102 to cause the dispatcher agent 104 to output a new request 106. As a non-limiting illustrative example, the computing system can provide the dispatcher agent 104 with input(s) 102 (e.g., natural language inputs, programming language inputs, computer-executable instructions, etc.) comprising one or more of: data indicating that a request 106 is invalid; data indicating a reason why the request 106 is invalid; data (e.g., natural language data, etc.) requesting a correction of the invalid request 106; data indicative of a proper format or syntax for a request 106; data indicative of one or more alternative requests 106, such as similar valid requests 106, with a suggestion to select one of the one or more alternative requests 106; or the like. As another example, in some instances, a computing system can, responsive to determining that a tool selection output of the request 106 is invalid, perform another error response action, such as calling a different machine-learned model (e.g., different agent 104, general-purpose multimodal sequence processing model, etc.); outputting an error message (e.g., to a user); or another action. Validating a tool call can include, for example, checking a syntax or format of the tool call for correctness; checking a tool identifier (e.g., name, etc.) or other tool selection output for correctness (e.g., whether a tool name correctly names a tool 108 the dispatcher agent 104 is authorized to access, etc.); checking a tool input or parameter for correctness (e.g., checking that a variable name refers to a variable in which relevant data has been stored, etc.); or the like.

In some examples, a tool 108 (e.g., worker agent 110) can include one or more machine-learned models (e.g., sequence processing model(s), language model(s), multimodal sequence processing model(s), etc.), and input(s) to the tool 108 can include in-context learning content for the machine-learned model. For example, in some instances, in-context learning content provided to a worker agent 110 can include any content described above with respect to input(s) 102 and in-context learning content provided to a dispatcher agent 104, with appropriate substitutions (e.g., in-context learning content indicative of second-worker-agent tools 116 instead of tools 108, etc.).

In some instances, a tool call can include one or more input parameters for the tool 108. In some instances, an input parameter included in a request 106 can include a variable name or other reference to a data structure to be provided as input to a tool 108 (e.g., “image”, etc.), and a tool manager module (e.g., interpreter, parser, glue code, etc.) can provide, as input(s) to the tool 108, the data structure itself; the reference included in the request 106; or another reference value (e.g., memory location, file location, variable name, etc.) to cause the tool 108 to access the data structure.

As a non-limiting illustrative example, in some example experiments according to aspects of the present disclosure, a dispatcher agent 104 prompted with in-context learning content associated with a TwoHopEncyclopedic worker agent 110 output a text-based request 106 comprising: “[Act]: TwoHopEncyclopedic(image, question)”, wherein “image” was a variable name associated with an input image provided to the dispatcher agent 104, and “question” was a variable name associated with a multi-hop question asked about the input image. In the experiments, a computing system parsed the request 106, identified the tool name “TwoHopEncyclopedic” and variable names “image” and “question”, and provided the TwoHopEncyclopedic tool with inputs comprising the image and the question referred to by the variable names “image” and “question”.

First tools 108 can include, for example, tools that are accessible to a dispatcher agent 104, such as tools 108 that are described in an input 102 provided to the dispatcher agent 104, or otherwise accessible to the dispatcher agent 104. Second-worker-agent tools 116 can include, for example, tools that are accessible to the second worker agent 110b, such as tools 116 that are described in a request 106 provided to the second worker agent 110b, or otherwise accessible to the second worker agent 110b. In some instances, a set of tools 108, 116 available to an agent 104, 110 can include one or more worker agents 110 and zero or more other tools 112.

In some instances, a set of tools 108, 116 can include one or more worker agents 110, such as a plurality of specialized worker agents 110 each configured to perform a specialized task or category of tasks that a dispatcher agent 104 may be tasked to perform or dispatch. In some instances, one or more worker agents 110 of a set of tools 108, 116 can include dispatcher agent(s) configured to select another worker agent 110 from a set of tools 116, or worker agents 110 that may perform a task directly (e.g., using one or more other tools 112 that are not worker agents 110; without necessarily using tools 108, 116; etc.).

In some instances, a worker agent 110 can have any property described herein with respect to a dispatcher agent 104, and vice versa. For example, in some instances, a worker agent 110 can be prompted with any in-context learning content described above with respect to a dispatcher agent 104, such as chain-of-thought prompting content (e.g., thought-observation-action content, etc.), instruction content, tool description content, or other in-context learning content. In some instances, a set of tools 116 available to a particular worker agent 110 (e.g., second worker agent 110b, etc.) may be different from (e.g., completely disjoint from, having some common elements and some non-overlapping elements, etc.) a set of tools 108 available to a dispatcher agent 104 or a set of tools 116 available to a different worker agent 110 (e.g., first worker agent 110a, etc.). For example, in some instances, a set of tools 108 available to a dispatcher agent 104 can include a general-purpose set of tools 108 comprising a plurality of specialized worker agents 110 (e.g., sub-dispatchers, etc.) that together are capable of performing a broad variety of tasks. Continuing the example, in some instances, a set of tools 116 available to a worker agent 110 called by the dispatcher agent 104 can include a more specialized set of tools 116 (e.g., worker agents 110, other tools 112, etc.) that together are capable of performing a narrower or more specialized variety of tasks associated with a specialty of the worker agent 110. For example, in some instances, each worker agent 110 can be configured to perform a set of one or more tasks that is a strict subset of a set of tasks that a dispatcher agent 104 is configured to perform using the worker agents 110. Further details of some example sets of tools 108, 116 are provided below with respect to FIG. 2.

In some instances, a worker agent 110 can include one or more multimodal machine-learned models for performing one or more multimodal machine learning tasks, such as vision language tasks. Further details of some example agents 104, 110 for performing vision language tasks are provided below with respect to FIG. 2.

In some instances, a set of agents 104, 110 and can form a multi-layer hierarchy of agents 104, 110, such as a hierarchy comprising a top-level dispatcher agent 104; a plurality of sub-dispatcher agents 110 each having a plurality of tools 116, such as a plurality of sub-dispatchers each associated with a respective category of tasks, with each sub-dispatcher having a plurality of worker agents 110 each associated with a specialty within the respective category; and so on. In some instances, a hierarchy of agents 104, 110 and tools 108, 116 can have any number of layers, wherein a layer is defined such that a dispatcher agent 104 is associated with a first layer (e.g., top layer, etc.); a worker agent 110 called by the dispatcher agent 104 is associated with a second layer; and a tool 108, 116 called by an agent 104 associated with an Nth layer is associated with an (N+1)th layer, where N can be a positive integer. In some instances, a tool 108, 116 can be associated with more than one level of a hierarchy, such as a tool 108, 116 that is available to more than one agent 104, 110.

An other tool 112 can include, for example, any tool 108, 116 that is not a worker agent 110. For example, in some instances, an other tool 112 can include a machine-learned model that is not configured to access tools 116; a non-machine-learned tool 108, 116; or other tool 108, 116 that is not a worker agent 110.

In some instances, a tool 108, 116 (e.g., worker agent 110, other tool 112, etc.) can be or include one or more software, firmware, or hardware components configured to perform actions selected by an agent 104, 110 (e.g., action(s) identified in a request 106, 114, etc.). In some instances, a tool 108, 116 can include one or more API tools having an application programming interface (API) that can be called to invoke the API tool. In some instances, a tool 108, 116 can include a tool 108, 116 that is executed or invoked in another manner, such as a tool 108, 116 comprising or associated with glue code configured to receive an action selection output (e.g., request 106, 114 comprising an action selection output, etc.) and perform one or more actions identified by the action selection. In some instances, an API of an API tool can be called directly by an agent 104, 110, or by another component (e.g., software, firmware, or hardware component, such as glue code, interpreter, compiler, etc.) based on an action selection output (e.g., request 106, 114, etc.) of the agent 104, 110.

An API tool 108, 116 (e.g., API-accessible other tool 112, etc.) can include, for example, any tool (e.g., hardware tool, software tool, firmware tool, etc.) that can be accessed via an API. For example, in some instances, an API tool can include software (e.g., application, operating system, etc.) installed on a device (e.g., mobile device, smartphone, etc.) running the machine-learned agent 104, 110; software available via a network (e.g., internet); hardware devices (e.g., internet-connected hardware devices, Bluetooth-connected hardware devices, etc.); etc. In some instances, a hardware API tool can include a hardware tool connected (e.g., via a network, via a wireless or wired connection, etc.) to a device running one or more machine-learned agents 104, 110. In some instances, an API tool can include a navigation API (e.g., map-related API, global positioning system-related API, etc.); a communication API (e.g., API associated with making phone calls, emails, or text messages such as SMS or MMS; APIs associated with communication applications, such as messaging applications, social media communication applications, etc.); a scheduling API (e.g., calendar, alarm, automated task scheduling, etc.); media player API (e.g., video player such as YouTube, audio player, etc.); shopping API; payment API such as Google Pay; mobile banking API; travel-related API (e.g., flight booking, hotel booking, etc.); or API of any application installed on a mobile device. In some instances, an API tool can include a hardware device such as a Bluetooth-connected lock, gate opener, garage door opener, etc.; an internet-connected doorbell or surveillance camera device; smart home device such as smart TV, smart appliance, lighting devices, thermostats, etc.; or any other API-accessible hardware tool.

In some instances, a tool 108, 116 can include a tool 108, 116 configured to perform one or more operations that may include a machine learning component, such as image processing (e.g., machine-learned image processing; image generation, visual question answering, visual identification such as facial recognition, image captioning, etc.), audio processing (e.g., machine-learned image processing; audio generation such as speech or music generation, speech-to-text or text-to-speech processing, audio identification such as voice identification, etc.), video processing (e.g., video generation, etc.), sequence processing (e.g., natural language sequence generation, natural language translation, question answering, computer code generation, etc.), robotics (e.g., robotic systems comprising machine-learned agent(s) configured to control physical manipulation tools, etc.), mobile digital assistants (e.g., smart phone assistants configured to perform communication actions, navigation actions, calendar actions, smart appliance control actions, etc.) or other action type. Other tool 108, 116 types are possible.

In some instances, a tool 108, 116 can output a response 118 to be provided, in whole or in part, to an agent 104, 110. Providing a response 118 to an agent 104, 110 can include, for example, directly providing the response 118, 120 from the tool 108, 116 to the agent 104, 110 (e.g., via an interface between the tool 108, 116 and the agent 104, 110, such as an API, etc.). Additionally or alternatively, providing a response 118, 120 to an agent 104, 110 can include providing the response 118, 120 to another component (e.g., software, firmware, or hardware component; interpreter, parser, glue code, etc.) that may provide the response 118, 120 or data indicative of the response 118, 120 to the agent 104, 110. In some instances, a tool 108, 116 can output an output 122 to be provided, in whole or in part, to a user or other entity (e.g., computing system, etc.), such as one or more entities that provided an input 102 or a computing component (e.g., interpreter, compiler, glue code, etc.) configured to receive outputs from a tool 108, 116 and provide corresponding input(s) to the agent 104, 110. In some instances, a tool 108, 116 can perform one or more actions that may not generate an output without deviating from the scope of the present disclosure.

In some instances, a request 114 can have any property described above with respect to a request 106, and vice versa. In some instances, a request 114 can be output by a worker agent 110 and can be indicative of a tool 116 or action selected by the worker agent 110. For example, in some instances, a request 114 can include data (e.g., language data, computer-executable instructions, name or identifier of one or more second-worker-agent tools 116, variable names or other parameter identifiers, function name, etc.) indicative of one or more second-worker-agent tools 116 selected by second worker agent 110b; one or more selected actions to be performed by the selected tool 116; one or more parameters or inputs associated with the selected action(s) or tool(s) 116; or the like.

In some instances, a request 114 output by a worker agent 110 can be the same as or different from a corresponding input to a tool 116 associated with the request 114. For example, request(s) 114 can be processed in any manner described above with respect to request(s) 106, and a corresponding input to a tool 116 indicated in a request 114 can have any property described above with respect to a corresponding input to a tool 108 indicated in a request 106.

Second-worker-agent tools 116 can include, for example, tools 116 (e.g., worker agents 110, other tools 112) that are accessible to the second worker agent 110b. For example, each of a plurality of worker agents 110 can each have a distinct toolset associated with a distinct set of specialized tasks that are different from a set of tasks associated with each other worker agent. As a non-limiting illustrative example, some example task sets and toolsets associated with a plurality of specialized vision-language agents 110 are described below with respect to FIG. 2.

A response 118 can generally include or otherwise represent various types of data. A response 118 can include one type or many different types of data. A response 118 can include one or more data types that are similar to (e.g., same as) or different from one or more data types of an input 102, request 106, or the like. Example data types for a response 118 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type.

Although FIG. 1 depicts a response 118 provided directly from a second tool 116b to a second worker agent 110b, in some instances, a response 118 output by a second tool 116b (e.g., to a tool manager module such as interpreter, parser, glue code, etc.) can be the same as or different from a corresponding input provided to a second worker agent 110b. As a non-limiting illustrative example, in some instances, a second tool 116b can include a machine-learned model (e.g., sequence processing model, language model, multimodal model, etc.) configured (e.g., fine-tuned, prompted with in-context learning content, etc.) to generate responses 118 having a first format or first mode, and a second worker agent 110b can include a machine-learned agent configured (e.g., fine-tuned, prompted with in-context learning content, etc.) to receive responses 118 having a second format or second mode. In such instances, a tool manager module can receive a response 118 in the first format from the second tool 116b, and can provide the response 118 in the second format to the second worker agent 110b. As a non-limiting illustrative example, in an example experiment according to aspects of the present disclosure, a plurality of agents 104, 110 were each configured to output final outputs (e.g., responses 118, 120; outputs 122; etc.) comprising line(s) of text beginning with the delimiter “[Finish]” and configured to receive, from tools 108, 116 called by the agents 104, 110, responses 118 comprising line(s) of text beginning with the delimiter “[Observe]”. In the example experiment, a computing system (e.g., tool manager module, etc.) received outputs comprising “[Finish]” from tools 108, 116, and provided, based on the outputs comprising “[Finish]”, related outputs comprising “[Observe]” (e.g., same line of text, with “[Finish]” replaced by “[Observe]”, etc.) to corresponding agents 104, 110 that selected the tools 108, 116. Additionally, in the example experiment, the computing system provided, in some instances, response 118 data to an agent 104, 110 having a different mode from data output by a tool 108, 116 selected by the agent 104, 110 (e.g., “The result is stored in the following variable: crop”, etc.). In some instances, the computing system provided response 118 data comprising a variable name in a first mode (e.g., text, etc.), and additional response 118 data in a second mode (e.g., image, etc.), such as by providing access to a data structure (e.g., “crop” variable data structure, etc.) in which the second-mode data is stored.

In some instances, a response 120 can have any property described herein with respect to a response 118, and vice versa. In some instances, a response 120 can be generated by a worker agent 110 based on one or more of a request 106 and response 118.

An output 122 can generally include or otherwise represent various types of data. An output 122 can include one type or many different types of data. An output 122 can include one or more data types that are similar to (e.g., same as) or different from one or more data types of an input 102. Example data types for an output 122 can include, for example, any data type described below with respect to FIGS. 6-7 and inputs 2, such as language data (e.g., natural language data such as text or speech data, programming language data, etc.), sequence data (e.g., language sequence, time series, etc.), image data, audio data, video data, or another data type. In some instances, an output 122 can include an output to be provided to a user or other entity (e.g., another computing system, etc.), such as an entity from which input(s) 102 were received. In some instances, an output 122 can include content that is responsive to the input(s) 102, such as an output 122 that answers a question contained in the input(s) 102; an output 122 that satisfies instruction(s) (e.g., natural language instructions, etc.) contained in the input(s) 102; or the like.

FIG. 2 is a block diagram of an example system for performing tasks including visual question answering tasks using hierarchical machine-learned agents according to example implementations of aspects of the present disclosure. A vision-language dispatcher agent 204 can receive one or more inputs 102, such as input(s) 102 indicative of a multimodal vision-language task to be performed. Based on the input(s) 102, the vision-language dispatcher agent 204 can select one or more vision-language tools 208 of a plurality of vision-language tools 208 to perform one or more actions. For example, the vision-language dispatcher agent 204 can select, responsive to receiving an input 102 comprising a multihop question answering task, a multihop retrieval QA agent 226, and can provide one or more requests 106 to the multihop retrieval QA agent 226, such as a request to answer a multihop question associated with the input(s) 102. Based on the request(s) 106, the multihop retrieval QA agent 226 can select one or more tools 216a of a plurality of tools 216a accessible to the multihop retrieval QA agent 226, and can send request(s) 114 to the tool(s) 216a; receive response(s) 118 from the tool(s) 216a; and provide response(s) 120 based on the response(s) 118 to a vision-language dispatcher agent 204, which can output one or more outputs 122 based on the response(s) 120.

For example, in some instances, the multihop retrieval QA agent 226 can select, responsive to receiving a request 106 comprising a multipart question, one or more decomposition tools 230 or single-hop retrieval QA agents 236 to perform one or more actions. For example, the multihop retrieval QA agent 226 can send, responsive to receiving a request 106 comprising a multipart question, a decomposition request 228 to a decomposition 230 tool requesting decomposition of the multipart question (or other multipart data) into multiple single-part questions (or other data). Continuing the example, the decomposition tool 230 can decompose the multipart data to generate a plurality of decomposed inputs 232 to provide to the multihop retrieval QA agent 226. Continuing the example, the multihop retrieval QA agent 226 can provide, based on one or more of the decomposed inputs 232, one or more question answering (QA) requests 234 to a single-hop retrieval QA agent 236. For each QA request 234, the single-hop QA agent can select one or more tools 216 of a plurality of tools 216c, and can send one or more requests to the tools 116c. For example, for each of one or more QA requests 234, the single-hop retrieval QA agent 236 can do one or more of: send a retrieval request 238 to a retrieval tool 240 and receive retrieved data 242 from the retrieval tool 240 based on the retrieval request 238; send a question answering (QA) request 244 to a question answering tool 246 based on the retrieved data 242; and generate a second QA response 250 based on a first QA response 248 received from the question answering tool 246. Based on one or more second QA responses 250 (e.g., plurality of QA responses 250 associated with a plurality of QA requests 234 associated with a plurality of decomposed inputs 232, etc.), the multihop retrieval QA agent 226 can provide a response 120 to the vision-language dispatcher agent 204, which can output one or more outputs 122 based on the response 120.

In some instances, a vision-language dispatcher agent 204 can be, comprise, be comprised by, or otherwise share one or more properties with a dispatcher agent 104 or worker agent 110. For example, in some instances, a vision-language dispatcher agent 204 can have any property described above with respect to a dispatcher agent 104 or worker agent 110, or vice versa. For example, in some instances, a system can include a top-level dispatcher agent 104 comprising, corresponding to, or sharing one or more properties with a vision-language dispatcher agent 204; a top-level dispatcher agent 104 that calls a vision-language dispatcher agent 204 as a tool 108; a worker agent 110 that calls a vision-language dispatcher agent 204 as a tool 116; or other arrangement.

A set of vision-language tools 208 can be, comprise, be comprised by, or otherwise share one or more properties with a set of first tools 108 or worker-agent tools 116. For example, in some instances, a set of vision-language tools 208 can have any property described herein with respect to a set of first tools 108 or a set of worker-agent tools 116, and vice versa. Similarly, in some instances, a vision-language tool 208 can have any property described herein with respect to a first tool 108 or worker-agent tool 116, and vice versa.

In some instances, a set of vision-language tools 208 can include one or more specialized vision-language worker agents 110 configured to perform specialized vision-language tasks, such as one or more single-hop retrieval visual question answering (VQA) agents 236; multihop retrieval VQA agents 226; spatial reasoning agents; optical character recognition (OCR)-based reasoning agents; single-hop or multi-hop visual question answering agents configured to answer a question associated with a specific region of an image; object identification agents; object counting agents; multi-image VQA agents; or other vision-language agents (e.g., image generation agents, language generation agents, image editing agents, language editing agents, etc.).

In some instances, each vision-language worker agent 110 of a set of vision-language tools 208 can include a set of worker-agent tools 116 comprising various kinds of tools 116 that can assist in specialized vision-language tasks. For example, in some instances, a vision-language worker agent 110 can have access to one or more of an entity identification tool, such as a tool to output a name (e.g., via text or natural language output, etc.) of an entity depicted in an input image (e.g., Google Lens, etc.); an object detection tool, such as a tool configured to generate one or more object identification outputs (e.g., bounding boxes, etc.) based on an input image and data indicative of an object category or class (e.g., natural language data such as “vase,” “yellow car,” etc.), such as a machine-learned model fine-tuned to generate object identification outputs; a yes/no object-in-image tool configured to generate a yes/no output indicating whether an object associated with an input category or class is depicted in an input image; an optical character recognition tool configured to generate text data in a text data format (e.g., ASCII data, Unicode data, etc.) based on an input image comprising a visual depiction of text; a caption tool (e.g., machine-learned vision-language model, such as model fine-tuned for caption generation, etc.) configured to generate a caption (e.g., natural language image description, text, etc.) based on an input image; a visual question answering tool (e.g., machine-learned model, etc.) configured to answer an input question based on an input image (e.g., simple input question regarding content depicted in the image, which may not require outside knowledge, etc.); an image cropping tool configured to output a cropped image based on an input image and input bounding box defining a cropping region; a spatial relationship tool configured to output, based on one or more input bounding boxes and an input (e.g., natural language input, etc.) indicative of a spatial relationship, an output bounding box having the spatial relationship with the input bounding box(es); a retrieval tool, such as a tool for retrieving data (e.g., factual data, natural language data, context data, etc.) from a data structure (e.g., database, etc.), website (e.g., Wikipedia, etc.), API, web search, or other data source; an AnswerWithContext tool configured to answer an input question based on an input context (e.g., retrieved context, etc.) and/or an input image; a question decomposition tool configured to decompose a question (e.g., multipart question or question requiring implicit knowledge or outside knowledge to answer) into two or more questions; or other relevant tools.

For example, in some instances, a vision-language tool 208 can include a multihop retrieval VQA agent 226 configured to answer a multihop input question based on an input image and based on context retrieved based on the input image or input question. Continuing the example, in some instances, a set of multihop-retrieval-agent tools 216a accessible to the multihop retrieval VQA agent can include a decomposition tool 230 configured to decompose an input question into two or more questions; a single-hop retrieval VQA agent 236 configured to answer a single-hop input question (e.g., generated by the decomposition tool 230 based on the multihop input question, etc.) based on an input image or retrieved input context; and one or more other tools 216b.

As another example, in some instances, a vision-language tool 208 or multihop-retrieval-agent tool 216a can include a single-hop retrieval VQA agent 236 having access to a plurality of single-hop-retrieval-agent tools 216c. Continuing the example, in some instances, a set of single-hop-retrieval-agent tools 216c can include a retrieval tool 240 configured to retrieve context based on one or more of an input image and input question; a question answering tool 246 configured to answer an input question based on an input image and input context (e.g., retrieved context, etc.); or other tools 216d (e.g., entity identification tool, etc).

Other examples are possible. For example, a toolset of a worker agent 110 configured to answer questions associated with a region of an image can include a question answer tool 246; a cropping tool; or other tools 216. As another example, a toolset of a spatial reasoning agent 110 can include a spatial relationship tool object detection tool, and other tools 216. As another example, a toolset of an OCR-based reasoning worker agent 110 can include an object detection tool, a crop tool, and one or more other tools 216 (e.g., caption tools, etc.). As another example, a toolset of a multi-image question answering agent 110 may include one or more single-image question answering worker agents 110; one or more cropping tools; one or more object identification or object counting tools; or other tools 216. As another example, a toolset of a worker agent 110 configured for complex counting tasks may include one or more object identification tools, cropping tools, visual question answering tools (e.g., agents 110 configured to answer questions about a region of an image, etc.), or other tools 216. In some instances, a tool 208 or tool 216 can include any tool 108, 116 described above with respect to FIG. 1.

In some instances, a multihop retrieval VQA agent 226 or single-hop retrieval VQA agent 236 can be, comprise, be comprised by, or otherwise share one or more properties with a worker agent 110. For example, in some instances, a multihop retrieval VQA agent 226 or single-hop retrieval VQA agent 236 can have any property described herein with respect to a worker agent 110, and vice versa. For example, in some instances, a multihop retrieval VQA agent 226 or single-hop retrieval VQA agent 236 can include a machine-learned model (e.g., sequence processing model, multimodal language model, etc.) configured to generate responses 118, 120 responsive to requests 106, 114 using one or more tools 216 (e.g., in any manner described above with respect to worker agents 110 of FIG. 1, etc.) For example, in some instances, a multihop retrieval VQA agent 226 or single-hop retrieval VQA agent 236 can be provided with in-context learning content (e.g., chain-of-thought example content such as thought-observation-action example reasoning chains, instruction content, system prompt content, etc.) indicative of a set of tools 216a, 216c, the in-context learning content configured to cause the agent 226, 236 to select one or more tools 216 from the set of tools 216a, 216c; output one or more requests 106, 114 to cause the tool(s) 216 to perform action(s); and generate response(s) 118, 120 based on output(s) of the tool(s) 216 or other data (e.g., input 102 data such as an input image, input query, etc.). As another example, in some instances, a multihop retrieval VQA agent 226 or single-hop retrieval VQA agent 236 can include a machine-learned model that has been fine-tuned with data indicative of a set of tools 216a, 216c from which the agent 226, 236 can select, such as input-output pairs comprising training input data (e.g., image data, user query data, etc.) and corresponding output data comprising a reasoning chain (e.g., reasoning chain comprising one or more tool selection outputs, thought-observation-action reasoning chain, output, etc.) and an output 122 (e.g., user output, etc.) associated with the reasoning chain.

In some instances, a multihop retrieval QA agent 226 can independently determine how many requests 228, 234 to output or how many tools 216a to use. For example, in some instances, a multihop retrieval QA agent 226 can generate, at each of a plurality of inference iterations, based on input(s) 102, request(s) 106, or other data generated or received by the multihop retrieval QA agent 226 (e.g., during prior inference iterations), one or more of: requests 106, 114, 228, 234, responses 118, 120, 250, chain-of-thought reasoning content (e.g., thought-action-observation reasoning content; text-based reasoning content comprising one or more delimiters such as “[Thought]”, “[Act]”, “[Observe]”, or “[Finish]”; etc.). At each of the plurality of inference iterations, a computing system can determine (e.g., using a parser, interpreter, glue code, etc.), based on the generated data (e.g., based on delimiters contained in the generated data, etc.) whether to call a tool 216a; generate additional data using the multihop retrieval QA agent 226; or provide a value (e.g., response 120, etc.) generated by the multihop retrieval QA agent 226 to another entity (e.g., vision-language dispatcher agent 204, etc.). For example, an “[Act]” indicator can be indicative of a request 106, 114 indicating that a tool 108, 116 should be called; a “[Finish]” delimiter can be indicative of a response 118, 120 to be returned to another agent 104, 110 that called the multihop retrieval QA agent 226; and a “[Thought]” delimiter can be indicative of reasoning content to be followed up with additional inference operations by the multihop retrieval QA agent 226. In some instances, an inference process can be repeated until a multihop retrieval QA agent 226 returns a response 120 or output 122 (e.g., response 120 indicated by a “[Finish]” delimiter, etc.).

More generally, any agent 104, 110 can independently determine how many tools 108, 116 to use in response to a given input 102 or request 106, 114 provided to the agent 104, 110. For example, at each inference iteration, an agent 104, 110 can independently determine whether to generate requests 106, 114; responses 118, 120 or outputs 122; or reasoning content, and a computing system (e.g., using an output parser, etc.) can determine, based on the generated data (e.g., based on delimiters of the generated data as described above), whether to cause a tool 108, 116 to perform an action; trigger an additional inference iteration of the agent 104, 110; or return an output of the agent 104, 110 to an entity that called the agent 104, 110 (e.g., other agent 104, 110 at a higher level in an agent hierarchy; user; other computing system; etc.). In some instances, an inference process of each agent 104, 110 or other tool 108, 116 can be repeated until the agent 104, 110 or other tool 108, 116 outputs a response 118, 120 or output 122 (e.g., indicated by a delimiter such as a “[Finish]” delimiter, etc.), at which point the response 118, 120 or output 122 can be provided to an appropriate entity.

In some instances, one or more of a decomposition request 228, QA request 234, retrieval request 238, and QA request 244 can be, comprise, be comprised by, or otherwise share one or more properties with a request 114. For example, in some instances, a decomposition request 228, QA request 234, retrieval request 238, or QA request 244 can have any property described herein with respect to a request 114, and vice versa.

In some instances, one or more of decomposed inputs 232, retrieved data 242, question-answering (QA) response 248, and QA response 250 can be, comprise, be comprised by, or otherwise share one or more properties with a response 118. For example, in some instances, decomposed inputs 232, retrieved data 242, a question-answering (QA) response 248, or a QA response 250 can have any property described herein with respect to a response 118, and vice versa.

In some instances, a single-hop-retrieval-agent tool 216c or multihop-retrieval-agent tool 216a (e.g., a decomposition tool 230, a single-hop retrieval QA agent 236, a retrieval tool 240, a question answering tool 246, an other tool 216b, 216d, etc.) can be, comprise, be comprised by, or otherwise share one or more properties with a worker-agent tool 116. For example, in some instances, a tool 216 can have any property described herein with respect to a tool 116, and vice versa.

In some instances, a decomposition request 228 can include a request 114 comprising data indicative of the decomposition tool; one or more inputs (e.g., natural language inputs such as questions, user requests, etc.) to be decomposed; parameters for the decomposition tool 230; or other request 114 data to cause the decomposition tool 230 to decompose first inputs to generate decomposed inputs 232.

A decomposition tool 230 can be or include one or more software, firmware, or hardware components configured to decompose one or more first inputs (e.g., natural language inputs, etc.) to generate a plurality of decomposed inputs 232, such as a machine-learned model (e.g., sequence processing model, language model, multimodal model, etc.) fine-tuned on input-output pairs comprising first inputs and decomposed inputs 232 generated from the first inputs; a machine-learned model provided with in-context learning data (e.g., chain-of-thought content, few-shot prompt content, example input-output tuples such as input-reasoning-output tuples, etc.) to cause the machine-learned model to generate decomposed inputs 232 (e.g., “In what city is the depicted building located? What is the Koppen climate classification for that city?”, etc.) based on first inputs (e.g., “What is the Koppen climate classification for the city in which the depicted building is located?”, etc.); or other decomposition tool 230.

Decomposed inputs 232 can include, for example, a plurality of values (e.g., natural language sequences, such as natural language questions, requests, or the like) generated from a single value to be decomposed (e.g., a single multi-part question, a question that may require implicit background knowledge to answer, etc.).

A QA request 234, 244 can include, for example, a request 114 to cause a tool 236, 246 configured for question answering to answer a question, such as a question contained in the decomposed inputs 232.

A retrieval request 238 can include, for example, data indicative of content to be retrieved, such as a name, identifier, encoding (e.g., machine-learned embedding vector, etc.), or other data indicative of content to be retrieved; data (e.g., computer code data, tool name data, etc.) to cause the retrieval tool 240 to retrieve data based on the data indicative of the content to be retrieved; or other data. As a non-limiting illustrative example, an example retrieval request 238 for retrieving encyclopedic content from Wikipedia can include a request 114 comprising a name of the retrieval tool and one or more inputs (e.g., natural language inputs, text inputs, etc.) indicative of content to be retrieved (e.g., “[Act]: WikipediaArticle (‘Alexandria’)”, etc.). As another example, an example retrieval request 238 for retrieving stored data from a database (e.g., vector database, etc.) can include an embedding vector indicative of content to be retrieved (e.g., based on a metric of similarity such as cosine distance between the embedding vector and a second embedding vector associated with the retrieved data 242, etc.) or data (e.g., natural language data, keyword data, phrase data, sentence data, etc.) from which an embedding vector can be generated. Other examples are possible.

A retrieval tool 240 can include, for example, any tool to return retrieved data 242 responsive to a retrieval request. For example, in some instances, a retrieval tool 240 can include one or more tools to retrieve data from a database (e.g., SQL database, NoSQL database, vector database, etc.), file, folder, or other data structure; one or more tools to retrieve data from a network (e.g., the internet), such as from one or more web sites; one or more search tools (e.g., internet search engines, etc.) to search for data to be retrieved; or other retrieval tools 240 (e.g., text retrieval tool, etc.).

Retrieved data 242 can include, for example, data retrieved based on a retrieval request 238. Example data types can include factual content (e.g., general knowledge data, encyclopedic data, publicly available data, private data accessible to an enterprise or individual using the retrieval tool 240, etc.), visual data (e.g., image data, video data, etc.), audio data, text data, natural language data, sequence data (e.g., computer code, etc.), multimodal data (e.g., visual data and language data, etc.), or other retrieved data 242.

A question answering tool 246 can include, for example, a tool configured to answer questions based on retrieved data 242 (e.g., retrieved data 242 provided as part of a QA request 244, etc.), such as a machine-learned model configured (e.g., using fine-tuning, chain-of-thought prompting, etc.) to perform question answering (e.g., visual question answering, etc.) based on retrieved data 242 (e.g., natural language factual content, etc.), such as a machine-learned model fine-tuned for visual question answering based on retrieved encyclopedic data (e.g., natural language data, etc.). Other implementations are possible.

A QA response 248 or QA response 250 can include, for example, a response 118, such as a response 118 comprising an answer to a question provided in a corresponding QA request 234, 244. In some instances, a QA response 250 can be the same as or different from a corresponding QA response 248 on which the QA response 250 was based (e.g., “[Finish]: BWh.”, etc.). For example, in some instances, a multihop retrieval QA agent 236 can decompose a multi-part question using a decomposition tool 230 to generate decomposed inputs 232 comprising a plurality of questions; provide, for each question of the plurality of questions, a QA request 234 to the single-hop retrieval agent 236; receive, for each question of the plurality of questions, a QA response 250 from the single-hop retrieval agent 236; and generate, based at least in part on the plurality of QA responses 250, a response 120, which can include content that is the same as or different from one or more of the QA responses 250.

As a non-limiting illustrative example, the examples below comprise transcripts generated by example vision-language dispatcher agents 204 and tools 208, 216 in example experiments according to example aspects of the present disclosure. In the example experiments, lines beginning with the delimiter [Observe] are outputs of a tool 208, 216 that were provided to an agent 104, 110 as input; lines beginning with the delimiter [Question] are input 102 content comprising a question to be answered; lines beginning with the delimiter [Act] are requests 106, 114 output by the agent 104, 110; line beginning with [Finish] are responses 118, 120 or outputs 122 generated by the agent 104, 110; and lines beginning with [Thought] are chain-of-reasoning outputs generated by the agent. (In the example experiments, the delimiters “[Act]”, “[Thought]”, and “[Finish]” are output tokens generated by the agent 104, 110, whereas other delimiters were input tokens provided to the agent 104, 110). In the example experiments, in-context learning content including chain-of-thought examples were provided to the agents 104, 110, but are omitted from the transcripts below.

### FIRST EXAMPLE EXPERIMENT

### Vision-Language Dispatcher Agent Transcript:

[Question] What is the Koppen climate classification for the city where this mosque is located?
[Thought] Let's caption the image.
[Act] Caption(image)
[Observe] a large building with two domes on top of it.
[Thought] To answer this question I need to identify the mosque, then find the city, and then the Koppen classification.
[Act] TwoHopEncyclopedic(image, question)

### Multi-Hop Retrieval Agent Transcript:

[Thought] I need to decompose the question into simpler questions.
[Act] DecomposeQuestion(question)
[Observe] In which city is this mosque located? What is the Koppen climate classification for this city?
[Thought] I need to answer the first question.
[Act] SingleHopEncyclopedic(image, “In which city is this mosque located?”)

### Single-Hop Retrieval Agent Transcript:

[Thought] I need to identify the mosque in the image
[Act] GoogleLens(image)
[Observe] Sidi Morsi Abu al-Abbas Mosque
[Thought] I need to retrieve the Wikipedia article.
[Act] article=WikipediaArticle(“Sidi Morsi Abu al-Abbas Mosque”)
[Observe] The result is stored in the variable: article.
[Thought] I need to answer the question using the article.
[Act] AnswerWithContext(“In which city is this mosque located?”, context=article)
[Observe] Alexandria.
[Finish] Alexandria.

### Multi-Hop Retrieval Agent Transcript (Continued):

[Observe] Alexandria
[Thought] Now I need to retrieve the Wikipedia article for Alexandria.
[Act] article=WikipediaArticle(“Alexandria”)
[Observe] The result is stored in the following variable: article.
[Thought] I need to answer the second question using the article.
[Act] AnswerWithContext(“What is the Koppen climate classification for this city?”, context=article)
[Observe] BWh.
[Finish] BWh.

### Vision-Language Dispatcher Agent Transcript (Continued):

[Observe] BWh
[Finish] BWh

### SECOND EXAMPLE EXPERIMENT

### Vision-Language Dispatcher Agent Transcript:

[Question]: When was this cathedral dedicated to st. dominic de guzman?
[Thought]: This question is about the dedication date of a cathedral. It requires external knowledge about the cathedral. It is an EncyclopedicSingleHop question.
[Act]: EncyclopedicSingleHop(‘When was this cathedral dedicated to st. dominic de guzman?’, image)

### Encyclopedic Single Hop Transcript:

[Question]: When was this cathedral dedicated to st. dominic de guzman?
[Thought]: First I need to identify the cathedral in the image.
[Act]: GoogleLens(image)
[Observe]: Bayombong Cathedral
[Thought]: Now I need to extract the article from the most confident entity.
[Act]: article=WikipediaArticle(“Bayombong Cathedral”)
[Observe]: I have stored the output of WikipediaArticle in the following variables: article.
[Thought]: Now I need to answer the question according to the article.
[Act]: AnswerWithContext (“‘When was this cathedral dedicated to st. dominic de guzman?’”, article)
[Observe]: Sep. 8, 1739
[Finish]: Sep. 8, 1739

### Vision-Language Dispatcher Agent Transcript (Continued):

[Observe]: Sep. 8, 1739
[Finish]: Sep. 8, 1739

### THIRD EXAMPLE EXPERIMENT

### Vision-Language Dispatcher Agent Transcript:

[Question]: what is the license plate?
[Thought]: Let's caption the image.
[Act]: Caption(image)
[Observe]: a yellow taxi cab parked on the side of the road.
[Thought]: To answer the question I need to read the license plate. This does not require external or encyclopedic knowledge, it is a non-encyclopedic question requiring OCR-based reasoning.
[Act]: OCRReasoning(‘what is the license plate?’, image)

### OCR Reasoning Agent Transcript:

[Question]: what is the license plate?
[Thought]: I need to find a license plate in the image.
[Act]: DetectObject(image, ‘license plate’)
[Observe]: license plate at
left: 174/top: 466/width: 141/height: 80, license plate at
left: 12/top: 317/width: 21/height: 26, license plate at
left: 659/top: 164/width: 47/height: 28
[Thought]: I found three potential license plates. I need to crop them.
[Act]: crops=CropImage (image, [[174, 466, 141, 80], [12, 317, 21, 26], [659, 164, 47, 28]])
[Thought]: I need to OCR the content of the license plates.
[Act]: OCR(crops)
[Observe]: [154-jdx new york, cannot answer—the image quality is too poor, cannot answer—the image quality is too poor].
[Finish]: 154-jdx new york

### Vision-Language Dispatcher Agent Transcript (Continued):

[Observe]: 154-jdx new york
[Finish]: 154-jdx new york

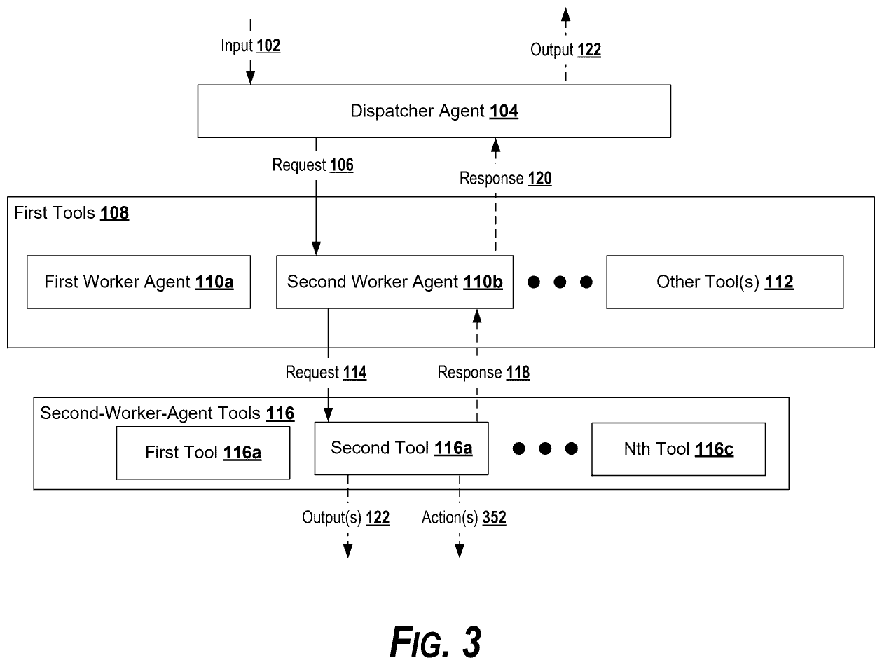

FIG. 3 is a block diagram of an example system for performing tasks using hierarchical machine-learned agents according to example implementations of aspects of the present disclosure. A dispatcher agent 104 can receive one or more inputs 102, such as an input 102 indicative of a task to be performed. Based on the input(s) 102, the dispatcher agent 104 can select one or more first tools 108, such as one or more worker agents 110 or other tools 112, to perform one or more actions 352. For example, the dispatcher agent 104 can select a second worker agent 110b of a plurality of worker agents 110, and can provide one or more requests 106 to the second worker agent 110, such as a request to perform a task associated with the input(s) 102. Based on the request(s) 106, the second worker agent 110b can select one or more tools (e.g., second tool 116b as depicted in FIG. 1) of a plurality of tools 116 accessible to the second worker agent 110b, and can send one or more requests 114 to the selected tool(s) 116. Based on the request(s) 114, the selected tool(s) 116 can perform one or more actions 352. In some instances, the actions 352 can include actions 352 that generate an output 122 or response 118, or actions 352 that do not include outputting an output 122 or response 118. In some instances, a tool 108, 116 can provide a response 118 to an agent 104, 110 using the tool, or can provide an output 122 to another entity (e.g., user, computing system, etc.).

Action(s) 352 can include, for example, one or more operations performed (e.g., computer-executable instructions executed, etc.) by a tool 108, 116. In some instances, an action 352 can include or not include generating output data, such as response(s) 118, 120 or outputs 122. In some instances, an action 352 can include or not include operations that change a state of a system, such as a computing system, physical system (e.g., machine, industrial system, robot, etc.), or other system. In some instances, an action 352 can include any operation described herein as being performed by a tool 108, 116 or any operation associated with a tool 108, 116 described herein (e.g., calendar update operation associated with a calendar tool, etc.).

In some instances, an output 122 can be generated or output (e.g., provided to a user, etc.) by any one of a dispatcher agent 104, worker agent 110, other tool 108, 112, 116, or the like, and any tool 108, 116 can perform operations that include or do not include providing a response 118, 120 to an agent 104, 110 that called the tool. For example, although FIG. 1 depicts responses 118, 120 being passed up a hierarchy of agents to a top-level dispatcher agent 104, which outputs an output 122, other implementations are possible without deviating from the scope of the present disclosure.

### Example Experiments

In some example experiments according to aspects of the present disclosure, systems comprising hierarchical agents 104, 110 according to aspects of the present disclosure were compared to alternative single-agent systems, including specialized single-agent systems configured to perform one specialized category of tasks, and general-purpose single-agent systems configured to perform a variety of task categories. In the example experiments, the hierarchical systems according to aspects of the present disclosure outperformed general-purpose single-agent systems on six out of eight specialized task categories tested, and performed similarly to specialized single-agent systems in each of the six categories. Additionally, in the example experiments, 59 percent of errors made by hierarchical systems according to aspects of the present disclosure were attributable to failures of other tools 112 that were not agents 104, 110. In contrast, 83 percent of errors made by general-purpose single-agent systems using the same toolset were failures of the agent itself, indicating that hierarchical agent-based structures according to aspects of the present disclosure improve the functioning of machine-learned agents.

In some additional example experiments according to aspects of the present disclosure, systems comprising hierarchical vision language agents 204, 110 according to aspects of the present disclosure were compared to alternative systems comprising a state-of-the-art non-agent-based vision-language model configured to perform multimodal machine-learned inference without the use of tools 108, 116. In the example experiments, hierarchical systems according to aspects of the present disclosure outperformed the vision language model in five out of eight datasets tested, with an average performance of 54.8 percent, compared to an average performance of 47.5 percent for the non-agentic vision-language model. In the example experiments, the three datasets in which the vision-language model outperformed hierarchical agent-based systems were datasets that were included in the vision-language model's training data, suggesting that hierarchical agent-based systems according to aspects of the present disclosure may outperform a non-agentic vision-language model when generalizing outside of a training dataset used to train the vision-language model.

### Example Methods

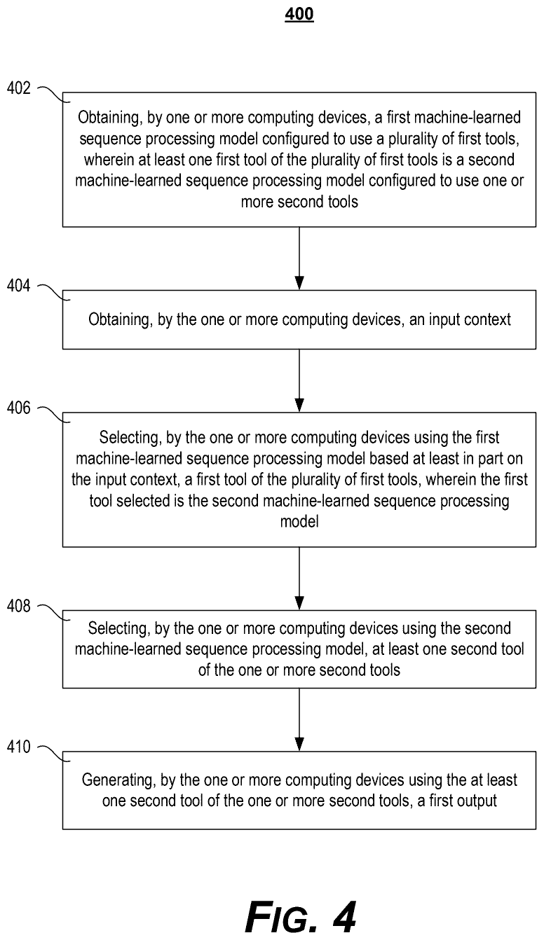

FIG. 4 depicts a flowchart diagram of an example method for machine-learned inference using hierarchical machine-learned agents according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include obtaining, by one or more computing devices, a first machine-learned sequence processing model (e.g., dispatcher agent 104, etc.) configured to use a plurality of first tools (e.g., first tools 108, etc.), wherein at least one first tool of the plurality of first tools is a second machine-learned sequence processing model (e.g., worker agent 110, etc.) configured to use one or more second tools (e.g., second tools 116, etc.). In some instances, example method 400 at 402 can include using one or more systems or performing one or more activities described with respect to FIGS. 1-3.

At 404, example method 400 can include obtaining, by the one or more computing devices, an input context (e.g., inputs 102, etc.). In some instances, example method 400 at 404 can include using one or more systems or performing one or more activities described with respect to FIGS. 1-3.

At 406, example method 400 can include selecting, by the one or more computing devices using the first machine-learned sequence processing model based at least in part on the input context, a first tool of the plurality of first tools, wherein the first tool selected is the second machine-learned sequence processing model. In some instances, example method 500 at 506 can include using one or more systems or performing one or more activities described with respect to FIGS. 1-3.

At 408, example method 400 can include selecting, by the one or more computing devices using the second machine-learned sequence processing model, at least one second tool of the one or more second tools. In some instances, example method 400 at 408 can include using one or more systems or performing one or more activities described with respect to FIGS. 1-3.

At 410, example method 400 can include generating, by the one or more computing devices using the at least one second tool of the one or more second tools, a first output (e.g., response 118, response 120, output 122, etc.). In some instances, example method 400 at 410 can include using one or more systems or performing one or more activities described with respect to FIGS. 1-3.

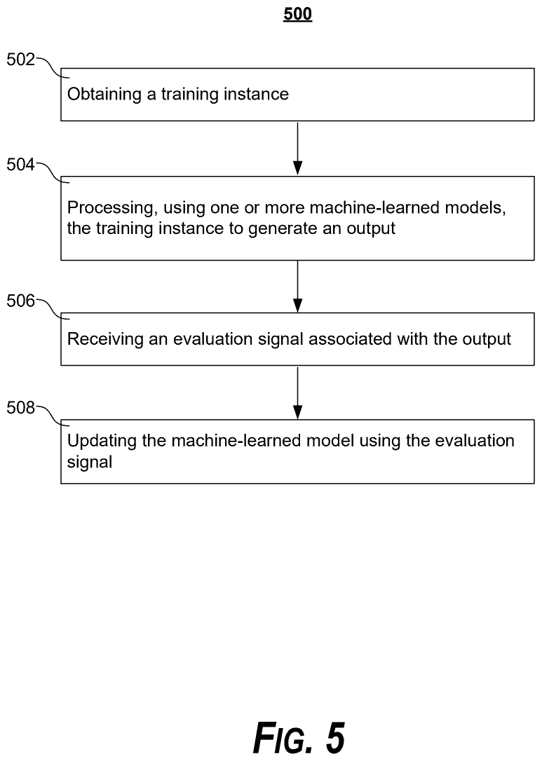

FIG. 5 depicts a flowchart of a method 500 for training one or more machine-learned models according to aspects of the present disclosure. For instance, an example machine-learned model can include a dispatcher agent 104 or worker agent 110.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types. In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of _.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

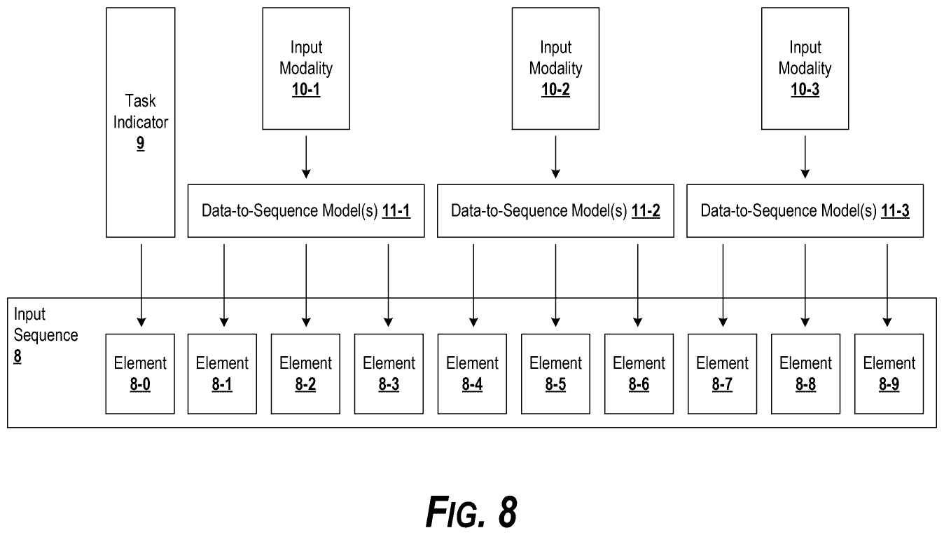

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

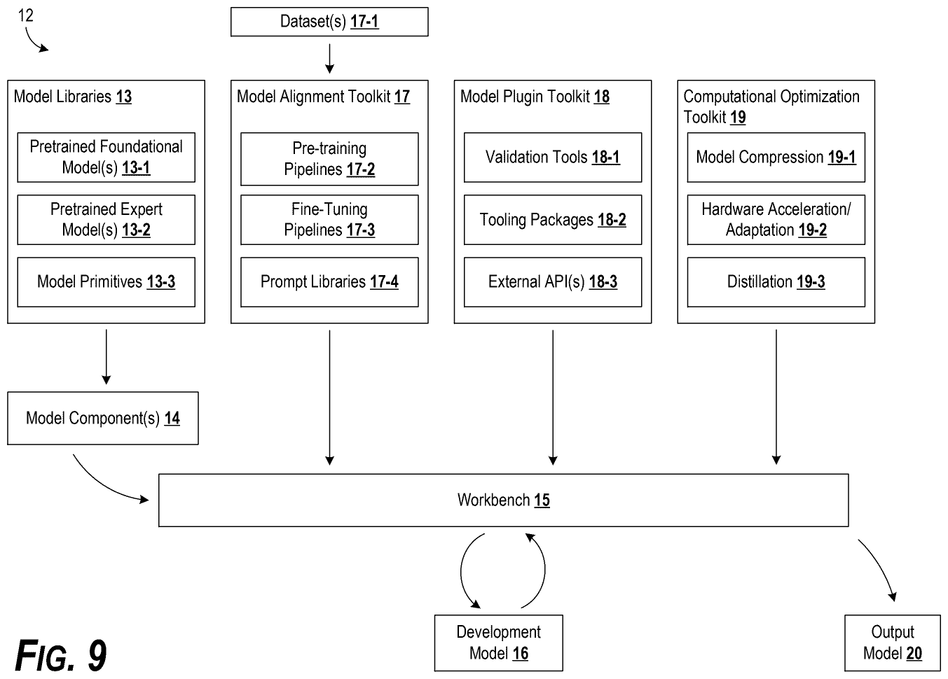

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

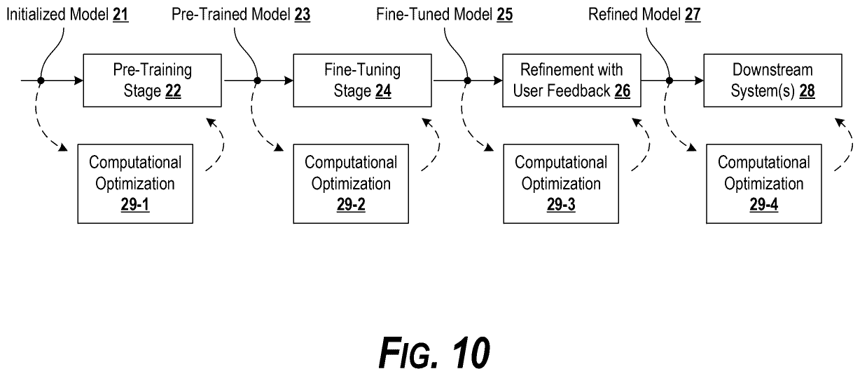

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

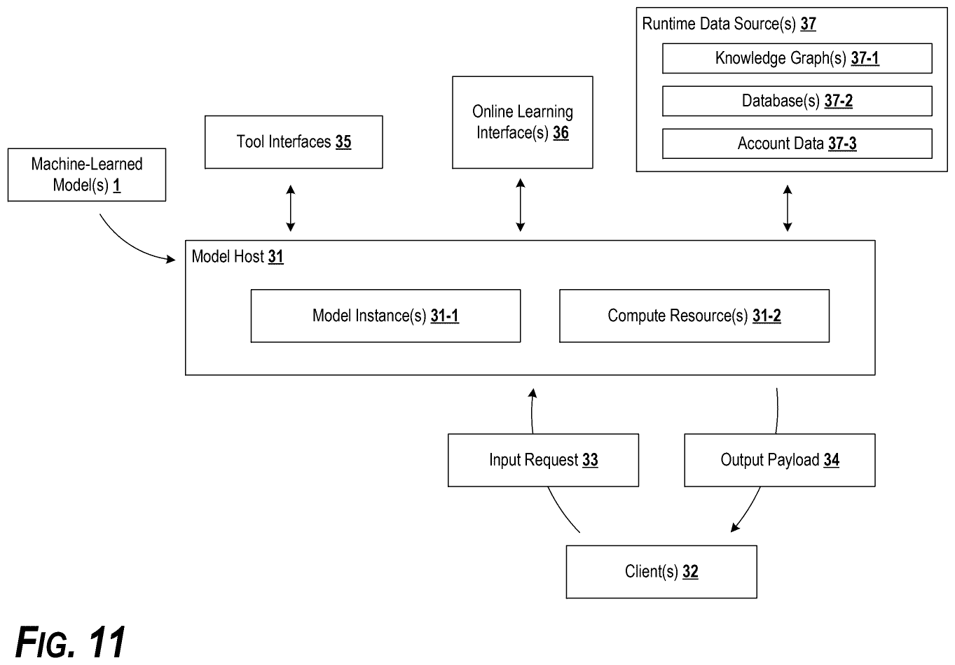

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

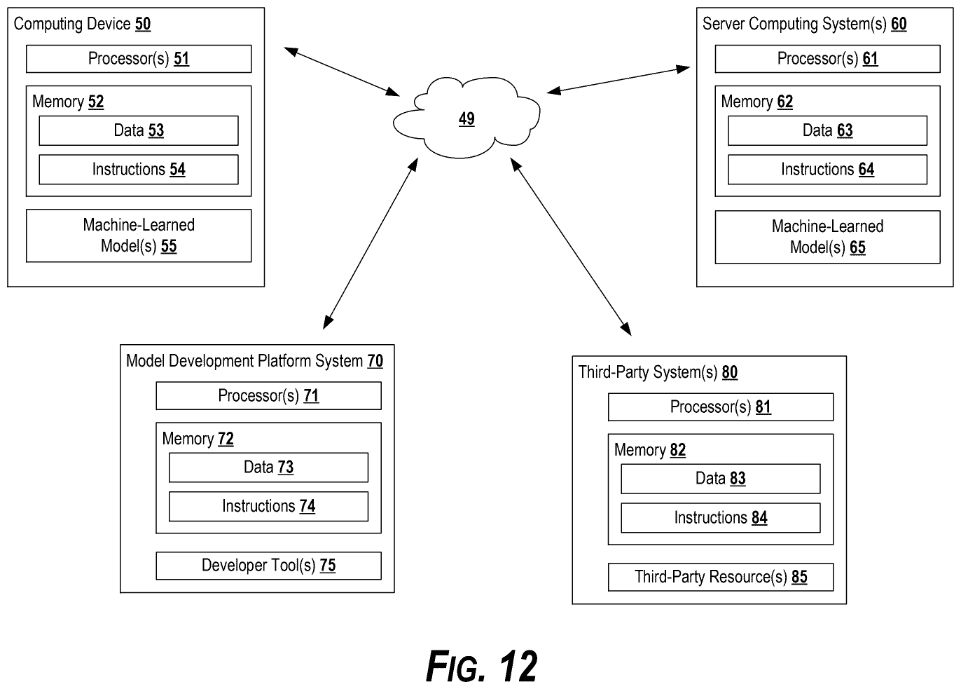

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

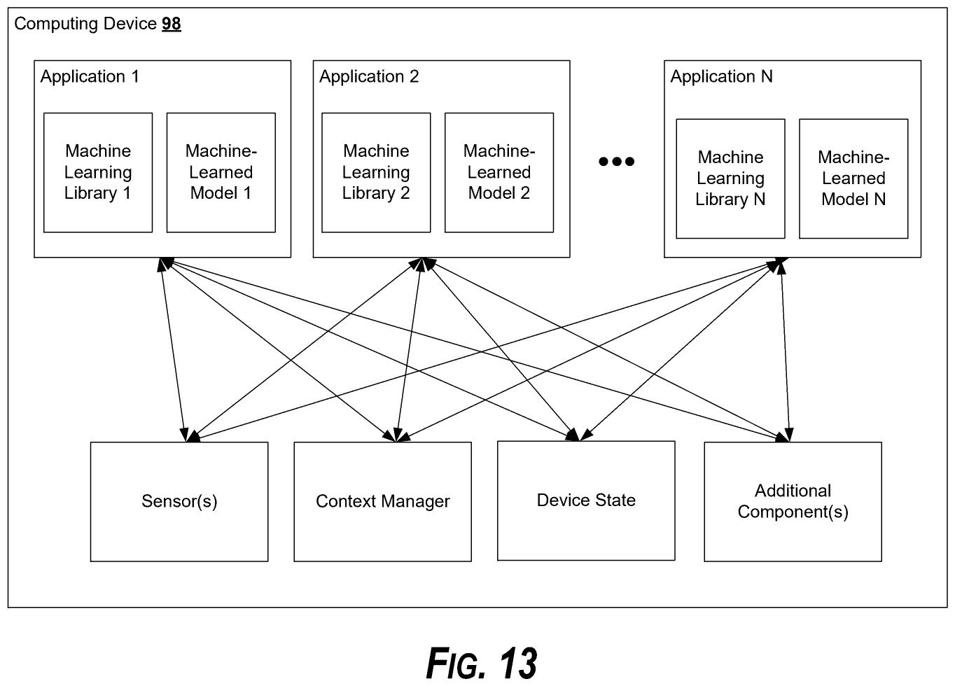

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

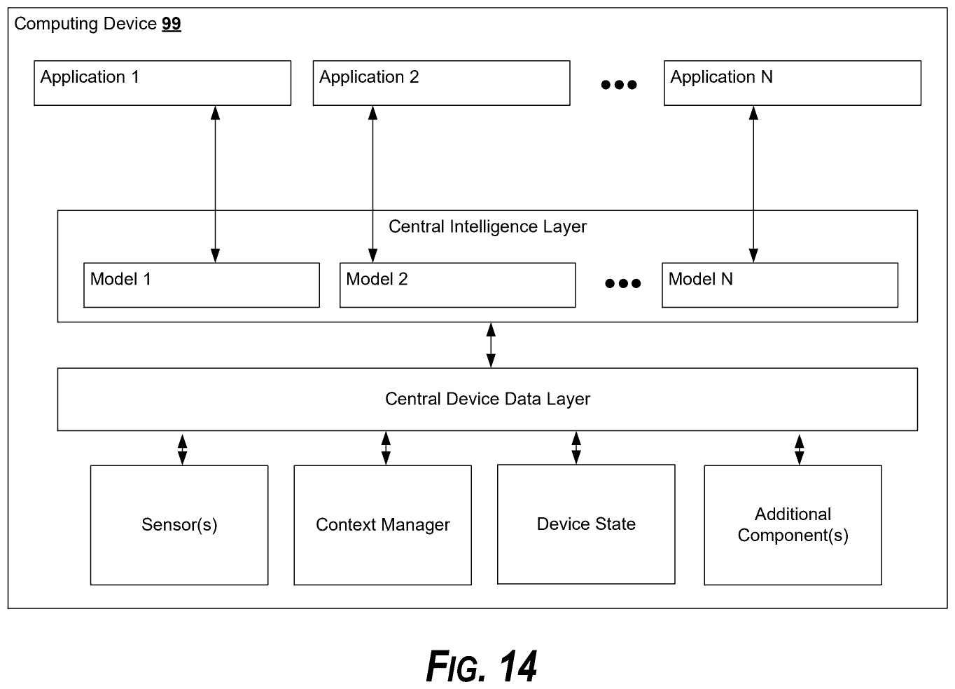

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for sequence generation using hierarchical machine-learned agents, comprising:
obtaining, by one or more computing devices, a first machine-learned sequence processing model configured to use a plurality of first tools, wherein at least one first tool of the plurality of first tools is a second machine-learned sequence processing model configured to use one or more second tools;
obtaining, by the one or more computing devices, an input context;
selecting, by the one or more computing devices using the first machine-learned sequence processing model based at least in part on the input context, a first tool of the plurality of first tools, wherein the first tool selected is the second machine-learned sequence processing model;
selecting, by the one or more computing devices using the second machine-learned sequence processing model, at least one second tool of the one or more second tools;
generating, by the one or more computing devices using the at least one second tool of the one or more second tools, a first output.

2. The computer-implemented method of claim 1, wherein the plurality of first tools comprises a plurality of respective machine-learned agents, wherein each respective machine-learned agent of the plurality of respective machine-learned agents is a machine-learned sequence processing model configured to use one or more respective tools usable by the respective machine-learned agent.

3. The computer-implemented method of claim 2, wherein at least one respective machine-learned agent of the plurality of respective machine-learned agents of the plurality of respective machine-learned agents is configured for visual question answering based on text retrieved using a text retrieval tool usable by the at least one respective machine-learned agent.

4. The computer-implemented method of claim 3, wherein the at least one respective machine-learned agent is configured to:
determine, using one or more third tools configured to name one or more entities depicted in one or more images, a name of a first entity depicted in an input image;
retrieve, using the text retrieval tool based on the name of the first entity, the text; and
output, based at least in part on the text, an answer to an input question.

5. The computer-implemented method of claim 2, wherein at least one respective machine-learned agent of the plurality of respective machine-learned agents is configured for counting a number of objects in an image.

6. The computer-implemented method of claim 2, wherein at least one respective machine-learned agent of the plurality of respective machine-learned agents is configured for answering a question about a particular portion of an image indicated by the input context.

7. The computer-implemented method of claim 2, wherein at least one respective machine-learned agent of the plurality of respective machine-learned agents is configured for multi-image question answering.

8. The computer-implemented method of claim 2, wherein at least one respective machine-learned agent of the plurality of respective machine-learned agents is configured for spatial reasoning.

9. The computer-implemented method of claim 2, wherein at least one respective machine-learned agent of the plurality of respective machine-learned agents is configured for reasoning based on optical character recognition.

10. The computer-implemented method of claim 9, wherein the at least one respective machine-learned agent is configured to:
identify, using one or more third tools based on an input image, one or more regions of the input image that comprise one or more natural language characters; and
read, using one or more fourth tools configured to perform optical character recognition, the one or more natural language characters.

11. The method of claim 2, wherein at least one respective machine-learned agent of the plurality of respective machine-learned agents is configured for performing multi-hop tasks using one or more decomposition tools configured to decompose an input to the at least one respective machine-learned agent.

12. The method of claim 1, wherein the at least one second tool comprises a third machine-learned sequence processing model.

13. The method of claim 12, wherein the third machine-learned sequence processing model is configured to use one or more third tools; and
generating the first output comprises:
selecting, by the one or more computing devices using the third machine-learned sequence processing model, at least one third tool of the one or more third tools; and
generating, by the one or more computing devices using the at least one third tool of the one or more third tools, a second output.

14. The method of claim 1, wherein at least one of the plurality of first tools and one or more second tools comprises a caption generator.

15. The method of claim 1, wherein at least one of the plurality of first tools and one or more second tools comprises an image cropping tool.

16. The computer-implemented method of claim 1, further comprising:
generating, by the one or more computing devices using the second machine-learned sequence processing model, one or more instructions for the at least one second tool;
wherein the one or more instructions comprise at least one variable name; and
the first output is generated based at least in part on data associated with the at least one variable name.

17. The computer-implemented method of claim 1, further comprising:
storing, on one or more non-transitory computer-readable media in one or more locations associated with a variable name, the first output;
generating, by the one or more computing devices using the second machine-learned sequence processing model, one or more instructions configured to use an additional tool of the one or more second tools; and
generating, by the one or more computing devices using the additional tool, a second output;
wherein the one or more instructions comprise the variable name; and
the second output is generated based at least in part on data associated with the variable name.

18. The computer-implemented method of claim 1, further comprising:
storing, on one or more non-transitory computer-readable media in a location associated with a variable name, the input context; and
generating, by the one or more computing devices using the first machine-learned sequence processing model, one or more instructions for the second machine-learned sequence processing model;
wherein the one or more instructions comprise the variable name; and
the at least one second tool of the one or more second tools is selected based at least in part on data associated with the variable name.

19. A computing system comprising one or more processors and one or more non-transitory computer-readable media storing instructions that are executable by the one or more processors to cause the computing system to perform operations, the operations comprising:
obtaining a first machine-learned sequence processing model configured to use a plurality of first tools, wherein at least one first tool of the plurality of first tools is a second machine-learned sequence processing model configured to use one or more second tools;
obtaining an input context;
selecting, using the first machine-learned sequence processing model based at least in part on the input context, a first tool of the plurality of first tools, wherein the first tool selected is the second machine-learned sequence processing model;
selecting, using the second machine-learned sequence processing model, at least one second tool of the one or more second tools;
generating, using the at least one second tool of the one or more second tools, a first output.

20. One or more non-transitory computer-readable media storing instructions that are executable by a computing system to perform operations, the operations comprising:
obtaining a first machine-learned sequence processing model configured to use a plurality of first tools, wherein at least one first tool of the plurality of first tools is a second machine-learned sequence processing model configured to use one or more second tools;
obtaining an input context;
selecting, using the first machine-learned sequence processing model based at least in part on the input context, a first tool of the plurality of first tools, wherein the first tool selected is the second machine-learned sequence processing model;
selecting, using the second machine-learned sequence processing model, at least one second tool of the one or more second tools;
generating, using the at least one second tool of the one or more second tools, a first output.
